(19) United States
(12) Patent Application Publication
(10) Pub. No.: US 2007/0236366 A1
(43) Pub. Date: Oct. 11, 2007

(54) Method and system for the acquisition of data and for the display of data

(76) Inventors: Joshua Gur, Jerusalem (IL); Ianiv Seror, Yehud (IL)

Correspondence Address: Gary M. Nath;THE NATH LAW GROUP, 112 South West Street, Alexandria, VA, 22314, US

(21) Appl. No.: 11/657,118

(22) Filed: Jan. 24, 2007

Related U.S. Application Data
(63) Continuation-in-part of application No. PCT/IL05/00790, filed on Jul. 25, 2005.

(30) Foreign Application Priority Data
Jul. 25, 2004 (IL) 163195

(51) Int. Cl. G08B 21/00

(52) U.S. Cl. 340/945

(57) ABSTRACT

A method and system are provided for acquiring data from an instrument panel or the like by obtaining images of the panel and optically identifying readings of the instruments in the image. The readings are in the form of geometrically identifiable forms having a meaning according to predetermined criteria. A coded data stream is created representative of the identified readings and transmitted to another location. The received data stream is then encoded and displayed on a virtual image of the instrument panel. The data stream can also be stored.

This is a Continuation-In-Part of International PCT Application No. PCT/IL2005/000790 filed Jul. 25, 2005 and claims priority from Israeli Patent Application no. 163195 filed Jul. 25, 2004, the contents of which are hereby incorporated by reference in their entirety.

### FIELD OF THE INVENTION

This invention relates to data acquisition and display systems. The invention finds particular application in small aircraft and the like, and in applications wherein acquisition of digital data directly from an instrument or a display may be otherwise complex or difficult.

### BACKGROUND OF THE INVENTION

Data recordal systems in large commercial aircraft or in military aircraft record instrumentation data directly from the instrumentation, and optionally also medical data and/or audio data regarding the crew, all of which can be of considerable use following the destruction of the aircraft due to an accident or other incident. Telemetry systems are also known for transmitting such data from a vehicle to a ground station. However, for small aircraft including trainer aircraft, such systems may carry a cost element of the order of the cost of the aircraft itself, which deters use thereof in such applications.

The use of cameras for visually recording flight instrumentation is known. For example, in U.S. Pat. No. 5,283,643 a pair of cameras, one external to the aircraft, and another mounted in the cockpit facing the instrument panel, is used to provide data regarding the flight of the aircraft. In general, low resolution recordal of instrument panels does not provide sufficiently clear readings of the instruments, while high resolution recordal is often impractical because of the cost related to the high memory requirements thereof. In WO 03/023730, a dual resolution camera is provided, which switches between a low resolution mode, to record the positions of control levers, and a high resolution mode, to record the instrument panel. In each case, actual video images of the instrument panel are recorded.

In U.S. Pat. No. 4,568,972 an attempt is made to overcome poor visual recording of instruments due to vibration and lighting effects. Rather than a cockpit camera, a plurality of fiber optic cables each comprises an objective lens at an end thereof focused on a particular instrument of an instrument panel, and the cables are operatively connected to a video camera for recordal.

However, in these publications, whatever video information that is recorded remains on the plane, and may be difficult to access in the event of destruction of the aircraft. Moreover, such recorded data is not transmitted to the ground, and would in any case be difficult or uneconomical to do so, as a suitable transmitter would have to be broad-band to carry the video signals.

In U.S. Pat. No. 5,742,336, an aircraft surveillance and recording system is described, comprising a plurality of cameras installed within and without the aircraft to record conditions thereat. One of the cameras that is located in the cockpit records the instrument panel. A microwave or SW radio transmitter must then be provided to transmit the video signals from the cameras, and digitized signals from the instruments on the instrument panel, to a satellite for relaying to a ground station.

In US 2003/0138146, methods, functional data, and systems are provided for image feature translation. An image is decomposed into sub images, each sub image having its features identified by feature attributes. The feature attributes are used to identify a particular feature within each sub image. The orientation of the particular feature within the sub image is then mapped or calculated to a value. One or more of the mapped or calculated values are translated into a reading associated with an instrument. The reading is then optionally recorded or transmitted.

In many prior art systems, the data recordal/acquisition systems are part of the avionics system, and are therefore not easily installable in aircraft other than the type for which they were designed. Taking images of the instrument panel according to the prior art, as has been discussed above, in practice requires high resolution, and in order to transmit this data very wide bandwidths are required, higher than 5 MHz. Radio transmission equipment required for such wide band transmission is typically expensive, as is the actual transmission channel that is required. Even using video compression techniques, the required bandwidths are still such as to require relative expensive radio transmission equipment, and in any case compression methods used in the art are lossy to the extent that details of the instrument panel in the image are lost. On the other hand, if lower bandwidths were to be used, the resolution is diminished, and the digits of the instrument panel monitors will be very unclear or even not visible in the received images.

Similar problems are encountered when desiring to transmit video images of the scenery outside the aircraft, for example as seen by the pilot—Either full bandwidth is required according to the prior art, requiring relatively expensive equipment and transmission channels, or the video signals need to be compressed, in which case details are lost.

Regarding the recordal of in-flight data, there are a host of digital recording systems available for this purpose, for both video images and other digital data such as instrument data. However, in order to be able to use such systems in an aircraft or other applications of interest, an avionics bus is required for extracting the digital signals from the respective instruments, and the avionics bus is a relatively high-cost item, for example in relation to a trainer aircraft.

Digital alarm systems are also known in the art, and warn a user when the reading on a particular instrument is approaching or within a critical domain. For example, such alarms may warn a pilot that the aircraft is approaching stall, or a power plant operator that there is insufficient cooling of a reactor or that steam pressure is rising above safe limits. However, such alarm systems of the art must be able to read digital data from the corresponding instruments, via an avionics bus for example or the like, in the absence of which such systems cannot be used.

Upgrades of avionics systems, such as helmet display systems for a pilot, are also well known, but similarly require the avionics system to be significantly changed or for data to be extracted from avionics buses, if available. Thus, such upgrades cannot be implemented where there is no avionics bus or where it is not desired, or where it is uneconomical, to radically change the avionic system. Similar situations also exist in non-aeronautical applications.

### SUMMARY OF THE INVENTION

Herein, “instrument panel” refers to any structure comprising at least one instrument, other display, control lever, button, knob or the like, or indeed to at least one instrument, other display, control lever, button, knob or the like, in which desired data may displayed, regardless of the format.

Herein, “instrument readout” or “instrument display” synonymously refer to any type or format of data as displayed by any instrument or display, and may include, but is not limited to, any of the following:—
the angular position of a dial in dial-type instruments,
alphanumeric characters displayed in any display, including LED-type displays, computer screens, printed output, and so on,
graphical output, displayed in any screen or printed display, for example,
bar displays, in which the magnitude of a parameter is proportional to or otherwise associated with the length of the bar,
the position of a control lever, button, knob or the like.

Herein “optical recognition operation” refers to the application of any suitable algorithm on an image to identify specific information from the image relating to the position, location, orientation, form, shape and so on of a particular area of interest in the image, for example the angular orientation of the image of a dial of a dial-type instrument.

Herein, “coded data stream” refers to a digital output which encodes information relating to an area of interest of an image. Such encoding may be in a non-video format, and is related to a geometric form identified in the area of interest of the image, rather than to the video nature of the pixels themselves that form that part of the image. In other words, such encoding typically involves providing a digitized bit sequence that represents a macro visual aspect of the image, rather than a digitization of the pixels that form the image, or a manipulation of the binary representation of the pixels of the image, including compression of this data. By macro aspect is meant a collection of pixels which when viewed or considered together in their relative spatial positions in the image have a particular meaning, typically by forming a geometrical shape or pattern that has a meaning according to predetermined criteria.

According to one aspect of the invention, a method is provided for acquiring data from an instrument panel having at least one instrument display wherein a value of a parameter being monitored via the display is associated with at least an angular disposition of an indicator with respect to the display comprising:—

(a) providing a first image of said at least one angular display comprising a plurality of image elements;

(b) transforming at least a portion of said first image into a corresponding R-θ image, wherein each said image element of the at least portion of said first image is relocated in said R-θ image to a position with respect to a first axis and a second axis according to the radius (R) and angular disposition (θ), respectively, of said image element with respect to a center and datum angle, respectively, in said first image;

(c) identifying said parameter value from said R-θ image by identifying an image corresponding to at least a part of said indicator therein and determining a position of said indicator with respect to said R-θ image;

(d) providing a coded data stream representative of said parameter value;

(e) at least one of transmitting and recording said coded data stream.

Optionally, step (a) comprises providing a global image of said panel having a plurality of said displays, and further comprising dividing the said global image into a corresponding plurality of said first images, each corresponding to a region of interest (ROI), wherein each said ROI comprising one said display, and wherein steps (b) to (e) may be performed for each said ROI.

According to an aspect of the invention, at least one said ROI comprises said indicator in the form of an image of a dial that points to the said parameter value, and step (c) comprises identifying a position of said dial in said R-θ image with respect to said second axis. The coded data stream may comprise digital values representative of said angular disposition. The method may further comprise serially compiling said coded data stream for each said ROI into a data package.

According to another aspect of the invention, the method may further comprise a calibrating procedure for determining a position of said center in said first image prior to step (a). The calibrating procedure may includes the sub steps:—

(i) providing a first calibration image of said at least one angular display;

(ii) analyzing said first calibration image to identify a center of rotation with respect to an angular rotation of said indicator.

The sub step (ii) may comprise:—

(ii-a) analyzing said first calibration image to identify a periphery of the display that is nominally circular about said center;

(ii-b) if said periphery is circular within a predefined tolerance determining and providing the location of said center;

(ii-c) if said periphery is not circular: (A) determining a calibration transformation required for elements of the said first calibration image such that said periphery in said calibration image is transformed to a circular shape in a second calibration image created via said calibration transformation; and (B) determining a location of a transformed center of the circular shape in the second calibration image.

The second calibration image may optionally be used as said first image in step (a).

Steps (a) to (d) may be applied to a plurality of said instrument displays of instruments that monitor at least engine conditions of at least one engine, and further comprising the step of analyzing said data stream with respect to reference data to obtain a measure of engine performance.

A method according to claim 10, wherein said analyzing step comprises comparing actual engine data as provided via said data stream with reference engine data obtained at substantially the same operating conditions to provide a deviation therebetween, and generating an alert when said deviation exceeds a predetermined threshold.

The method may further comprise the step of recording said coded data streams in a crash proof device.

Optionally, step (c) comprises transmitting said coded data streams by means of a radio signal.

The parameter may include, by way of example, at least any one of airspeed, altitude, pitch, roll, yaw, turn rate, vertical speed, horizontal situation (compass heading), engine rpm, oil status, fuel status, oil temperature, Mach number, chronological time.

The method may further comprise the step of providing at least one second image of an external environment, and/or the step of providing at least one of: attitude data, GPS data, DGPS data, altitude data, voice data. The method may further comprise the steps:—

(A) providing a virtual image corresponding to the said external environment corresponding to said at least one said second image;

(B) comparing said at least one second image with said corresponding virtual image;

(C) identifying differences between the images in step (B).

A method according to claim 17, further comprising providing digital data representative of said differences in step (C) and optionally displaying said digital data.

The method may further comprise including at least one of said attitude data, GPS data, DGPS data, altitude data, voice data, said digital data representative of said differences in step (C), in said coded data stream.

The image element may comprise, for example, at least one pixel.

According to a further aspect of the invention, a method is provided for alerting regarding non authorized users, comprising providing an image of a user that is facing the instrument panel, analyzing said image and comparing with images of authorized users, and further comprising the step of generating an alert if the said user image does not match at least one authorized user image.

According to a further aspect of the invention, a method is provided for displaying data comprising:—

(i) at least one of receiving and reading a coded data stream representative of an image of said at least one display of an instrument panel;

(ii) creating an image of said at least one readout based on said corresponding said coded data stream;

(iii) displaying said image in the context of an image representative of said panel.

The coded data stream may be previously created by imaging said at least one instrument panel display to provide a first image thereof, and manipulating said first image to provide said coded data stream, wherein said coded data stream is representative of at least one value of a parameter being monitored at the display.

The coded data stream may be previously created according to a method for acquiring data from an instrument panel having at least one instrument angular display wherein a value of a parameter being monitored at the display is associated with at least an angular disposition with respect to the display comprising:—

(a) providing a first image of said at least one angular display

(b) transforming at least a portion of said first image into a corresponding R-θ image, wherein each said image element of the at least portion of said first image is relocated in said R-θ image to a position with respect to a first axis and a second axis according to the radius (R) and angular disposition (θ), respectively, of said image element with respect to a center and datum angle, respectively, in said first image;

(c) identifying said parameter value from said R-θ image by identifying an image corresponding to at least a part of said indicator therein and determining a position of said indicator with respect to said R-θ image;

(d) providing said coded data stream, wherein said data stream is representative of said parameter value;

(e) at least one of transmitting and recording said coded data stream.

At least one said coded data stream relates to a dial of a dial-type instrument, and step (ii) comprises creating an image of a dial at an angular disposition of said dial with respect to a datum, said angular position being correlated with said coded data stream. The coded data stream may comprise digital values representative of said angular disposition. The parameter may include at least one of airspeed, altitude, pitch, roll, yaw, turn rate, vertical speed, horizontal situation (compass heading), engine rpm, oil status, fuel status, oil temperature, Mach number, chronological time.

The method may further comprise the step of displaying at least one of said attitude data, GPS data, DGPS data, altitude data, voice data, said digital data representative of said differences in step (C), in said coded data stream.

Optionally, the method may comprise:

providing a flight simulator program having capabilities of simulating a flight and of displaying instruments displays indicative of said flight from a vantage point of a user, wherein inputs for driving the instruments displays are normally provided by manipulation of suitable flight controls by said user;

adapting at least one of said flight simulator program and said coded data stream such that said inputs for said instruments displays are provided by said coded data stream.

According to a further aspect of the invention, a system is provided for the acquisition of data from an instrument panel comprising at least one instrument angular display wherein a value of a parameter being monitored at the display is associated with at least an angular disposition of an indicator with respect to the display, comprising:—

(a) at least one first camera for providing a first image of said at least one display;

(b) processing system for processing said first image of said at least one display to provide a coded data stream representative of said image via a method comprising:—

(I) transforming at least a portion of said first image into a corresponding R-θ image, wherein each said predefined image element of the at least portion of said first image is relocated in said R-θ image to a position with respect to a first axis and a second axis according to the radius (R) and angular disposition (θ), respectively, of said predefined image element with respect to a center and datum angle, respectively, in said first image;

(II) identifying said parameter value from said R-θ image;

(III) providing said coded data stream, wherein said coded data stream is representative of said parameter value;

(c) at least one of transmitting apparatus and recording apparatus for transmitting and recording, respectively, said coded data stream.

The panel may comprise a plurality of said displays, and said processing system is adapted for dividing the said image into a corresponding plurality of regions of interest (ROI), each said ROI comprising one said display, wherein said processing system processes said first image of each said readout to provide a corresponding plurality of coded data streams representative of said images.

At least one fiducial marker may be provided on said panel for aligning the said ROI with respect to an image of said marker. Optionally, the fiducial comprises a white outer annular portion circumscribing a dark central portion.

In some embodiments, the at least one first camera and said panel are comprised in an aircraft cockpit. Optionally, a crash proof device may be provided, operatively connected to said processing system for recording said coded data streams therein. The transmission apparatus may comprise a suitable radio transmitter. The system may further comprise at least one second camera for obtaining images of an external environment. The system may optionally further comprise at least one of: attitude data module, GPS system, DGPS system, altitude module, voice compression module.

According to a further aspect of the invention, a system is provided for displaying data comprising:—

(i) at least one of data receiving apparatus and reading apparatus for receiving and reading, respectively, a coded data stream representative of an image of said at least one readout of an instrument panel;

(ii) processing apparatus for creating an image of said at least one readout based on said corresponding said coded data stream;

(iii) displaying apparatus for displaying said image in the context of an image representative of said panel.

The coded data stream may be created by imaging said at least one instrument panel display to provide a first image thereof, and manipulating said first image to provide said coded data stream, wherein said coded data stream is representative of at least one value of a parameter being monitored at the display.

The coded data stream may be created according to a method for acquiring data from an instrument panel having at least one instrument angular display wherein a value of a parameter being monitored at the display is associated with at least an angular disposition with respect to the display comprising:—

(a) providing a first image of said at least one angular display

(b) transforming at least a portion of said first image into a corresponding R-θ image, wherein each said image element of the at least portion of said first image is relocated in said R-θ image to a position with respect to a first axis and a second axis according to the radius (R) and angular disposition (θ), respectively, of said image element with respect to a center and datum angle, respectively, in said first image;

(c) identifying said parameter value from said R-θ image by identifying an image corresponding to at least a part of said indicator therein and determining a position of said indicator with respect to said R-θ image;

(d) providing said coded data stream, wherein said data stream is representative of said parameter value;

(e) at least one of transmitting and recording said coded data stream.

The processing apparatus may be adapted for at least one of receiving and reading a data package comprising a plurality of said coded data streams, each representative of an image of one of a plurality of displays of said instrument panel.

The processing apparatus is adapted for dividing the data package into a corresponding plurality of coded data streams, and said display apparatus is adapted for displaying each image corresponding to a coded data stream in a window of said panel image corresponding to the position of the corresponding readout of said instrument panel.

According to a further aspect of the invention, a computer readable medium storing instructions for programming a processing means of a system to perform a data acquisition method and/or a data display method according to another aspects of the invention.

According to a further aspect of the invention, a method is provided for providing a simulation in a first location of an instrument status at a second location, comprising:

providing an image of an instrument having said instrument status at said second location;

analyzing said image to provide a measure of said instrument status;

providing a coded data stream representative of said measure of said instrument status;

transmitting said coded data stream to said first location

receiving said coded data stream at said first location;

simulating said instrument status by reconstructing and displaying a virtual image corresponding to said instrument based on said coded data stream, such that said virtual image comprises a representation of said instrument status.

According to a further aspect of the invention, a system is provided for providing a simulation in a first location of an instrument status at a second location, comprising:

at least one first camera for providing an image of said instrument at said second location;

first processing system for analyzing said image to provide a measure of said instrument status, and for providing a coded data stream representative of said measure of said instrument status;

transmitting apparatus for transmitting said coded data stream to said first location;

receiving apparatus at said first location for receiving said coded data stream;

second processing system for simulating said instrument status by reconstructing a virtual image corresponding to said instrument based on said coded data stream, such that said virtual image comprises a representation of said instrument status, and first display apparatus for displaying said virtual image.

The system may further comprise a second display apparatus coupled to a flight simulation processor for displaying at said second location computer generated images of said instrument, and wherein said at least one camera is focused on said second display.

According to a further aspect of the invention, a computer readable medium storing instructions for programming a processing means of a system to perform a method of providing a simulation in a first location of an instrument status at a second location according to another aspects of the invention.

In accordance with another aspect of the present invention, a system and method are provided for the acquisition of data from an instrument panel comprising at least one instrument, and a system and method are provided for the display of data thus acquired.

The data acquisition method comprises:—

(a) providing an image of said at least one readout;

(b) providing a coded data stream representative of said image of said at least one readout;

(c) at least one of transmitting and recording said coded data stream.

The image may comprise at least one optically identifiable geometric form and said coded data stream is representative of at least one parameter associated with the geometric form.

Typically, step (a) comprises providing an image of said panel having a plurality of said readouts, and further comprising dividing the said image into a corresponding plurality of regions of interest (ROI), each said ROI comprising one said readout, wherein step (b) is performed for each ROI.

Step (b) comprises performing an optical recognition operation on said image of said readout to provide said coded data stream.

Typically, at least one said ROI comprises an image of a dial of a dial-type instrument, and said operation comprises optically identifying an angular disposition of said dial with respect to a datum, and the coded data stream comprises digital values representative of said angular disposition.

Optionally, at least one said ROI comprises an image of at least one alphanumeric character, and said operation comprises optically identifying said at least one character, and said coded data stream comprises digital values representative of said character.

Optionally, at least one ROI comprises an image of a bar display of a bar-type instrument, and said operation comprises optically identifying a length of said bar display with respect to a datum, and the coded data stream comprises digital values representative of said length.

Optionally, at least one ROI comprises an image of a control lever, button, knob or the like, and said operation comprises optically identifying a position of control lever, button, knob or the like with respect to a datum, and the coded data stream comprises digital values representative of said position

The digital values are typically in ASCII format, and the datums typically refer to a zero reading or position for each said readout.

The method optionally further comprises serially compiling said coded data stream for each said ROI into a data package. In such cases steps (a) to (c) may be performed to provide a said data package at predetermined time intervals, a fresh image of said at least one readout being procured at each said time interval. The time interval may be any one of or any value between any pair of 0.01, 0.1, 0.25, 0.5, 1, 5, 10, 20, 30 or 60 second intervals, or less than 0.01 seconds or greater than 60 seconds.

The method preferably comprises the step of aligning the said ROI with respect to an image of a datum marker provided on said panel. Optionally, the method further comprises the step of calculating an absolute value corresponding to one said readout from said digital values according to predetermined rules.

Typically, the panel is comprised in an aircraft cockpit. Optionally, the coded data streams are recorded in a crash proof device. Typically, step (c) comprises transmitting said coded data streams by means of a radio signal

Optionally, the method further comprises the step of providing at least one second image of an external environment.

Optionally, the method further comprises the step of providing at least one of: attitude data, GPS data, DGPS data, altitude data, voice data. Further optionally, the method further comprises the steps:—

providing a virtual image corresponding to the said external environment corresponding to said at least one said second image;

comparing said at least one second image with said corresponding virtual image;

identifying differences between the images in step (C).

The method optionally further comprises providing digital data representative of said differences in step (C) and optionally displaying said digital data. Optionally, at least one of said attitude data, GPS data, DGPS data, altitude data, voice data, said digital data representative of said differences in step (C), are included in said coded data stream.

The present invention also relates to a method for displaying data comprising:—

(i) at least one of receiving and reading a coded data stream representative of an image of said at least one readout of an instrument panel;

(ii) creating an image of said at least one readout based on said corresponding said coded data stream;

(iii) displaying said image in the context of an image representative of said panel.

Typically the coded data stream is created according to the data acquisition method of the invention.

Typically, step (i) comprises at least one of receiving and reading a data package comprising a plurality of said coded data stream, each representative of an image of one of a plurality of readout of said instrument panel.

Typically, in step (ii) the data package is divided into a corresponding plurality of coded data streams, and wherein in step (iii) each image corresponding to a coded data stream is displayed in a window of said panel image corresponding to the position of the corresponding readout of said instrument panel.

Typically, at least one said coded data stream relates to a dial of a dial-type instrument, and step (ii) comprises creating an image of a dial at an angular disposition of said dial with respect to a datum, said angular position being correlated with said coded data stream, and the coded data stream comprises digital values representative of said angular disposition.

Optionally at least one said coded data stream relates to at least one alphanumeric character, and step (ii) comprises creating an image of said at least one character, and the coded data stream comprises digital values representative of said character.

Optionally, at least one said coded data stream relates to display of a bar-type instrument, and step (ii) comprises creating a bar display having a first length with respect to a datum, said first length being correlated with said coded data stream, and the coded data stream comprises digital values representative of said first length.

Optionally, at least one said coded data stream relates to a position of a control lever, button, knob or the like, and step (ii) comprises creating an image of the same at a first position with respect to a datum, said first position being correlated with said coded data stream, and the coded data stream comprises digital values representative of said first position

Typically, the digital values are in ASCII format, and the datums refer to a zero reading or position for each said readout.

Typically, steps (i) to (iii) are performed with respect to a plurality of said data package serially received or read at predetermined time intervals, which may be for example any one of or any value between any pair of 0.01, 0.1, 0.25, 0.5, 1, 5, 10, 20, or 60 second intervals, or less than 0.01 seconds or greater than 60 seconds. Optionally, the method may comprise the step of calculating an absolute value corresponding to one said readout from said digital values according to predetermined rules. The panel image comprises appropriate indicia with respect to said windows corresponding to indicia comprised in said readouts of said panel. These indicia can correspond to instrument scales, so that the position of the dials etc in the image can be read against the scales to enable the data displayed by the images to be read by an observer.

Typically, the said coded data stream is created according to the method of the invention. Optionally, the method further comprises the step of displaying at least one of said attitude data, GPS data, DGPS data, altitude data, voice data, said digital data representative of said differences in step (C), in said coded data stream. Further optionally, the method comprises displaying a said virtual image corresponding to said at least one said second image and including in said virtual image said digital data representative of said differences in step (C), in said coded data stream.

The system for the acquisition of data from an instrument panel comprising at least one instrument readout, may comprise:—

(a) at least one camera for providing an image of said at least one readout;

(b) processing means for processing said image of said at least one readout to provide a coded data stream representative of said image;

(c) at least one of transmitting means and recording means for transmitting and recording, respectively, said coded data stream.

Typically, the image is captured in a frame grabber operatively connected to said processing means prior to processing thereby. The panel typically comprises a plurality of said readouts, and said processing means is adapted for dividing the said image into a corresponding plurality of regions of interest (ROI), each said ROI comprising one said readout, wherein said processing means process said image of each said readout to provide a corresponding plurality of coded data streams representative of said images.

At least one a datum marker may be provided on said panel for aligning the said ROI with respect to an image of said marker.

The processing means is adapted for performing an optical recognition operation on said image of each said readout to provide said coded data stream, and may thus comprise an optical processor. The processing means is adapted for perform the data acquisition method of the invention. Typically, the camera and panel are comprised in an aircraft cockpit, but the system may be adapted for any suitable static structure such as for example a power plant instrument panel, or any vehicle or the like, including a tank, car, yacht and so on.

The system preferably further comprises a crash proof device operatively connected to said processor for recording said coded data streams therein. The transmission means typically comprises a suitable radio transmitter.

The system optionally comprises at least one second camera for obtaining images of an external environment, and/or at least one of: attitude data module, GPS system, DGPS system, altitude module, voice compression module. The processing means is adapted for carrying out the method according to the invention. Preferably, the system further comprises means for displaying said digital data representative of said differences in step (C).

The present invention is also directed to a system for displaying data comprising:—

(i) at least one of data receiving means and reading means for receiving and reading, respectively, a coded data stream representative of an image of said at least one readout of an instrument panel;

(ii) processing means for creating an image of said at least one readout based on said corresponding said coded data stream;

(iii) displaying means for displaying said image in the context of an image representative of said panel.

Typically, the coded data stream is created according to the data acquisition method of the invention.

The processing means is typically adapted for at least one of receiving and reading a data package comprising a plurality of said coded data streams, each representative of an image of one of a plurality of readouts of said instrument panel. The processing means is also typically adapted for dividing the data package into a corresponding plurality of coded data streams, and said display means is adapted for displaying each image corresponding to a coded data stream in a window of said panel image corresponding to the position of the corresponding readout of said instrument panel. The processing means is typically adapted for perform the data display method of the invention.

The present invention also relates to a computer readable medium storing instructions for programming a processor means of the data acquisition system of the invention to perform a data acquisition method of the invention.

The present invention also relates to a computer readable medium storing instructions for programming a processor means of a data display system of the invention to perform the data display method of the invention.

Thus, the present invention provides advantages over prior art data acquisition and display systems. For example, transmission of effectively compressed images of the instrument panel and other data may be transmitted for debriefing purposes or for monitoring purposes, in effectively real time or close thereto, and using full bandwidths.

The present invention may be used as a real-time debriefing system (RDS) for training, monitoring and debriefing pilots and the like. A flight profile may be set up, for example using flight simulators available in the market, such as for example Microsoft Flight Simulator, using data such as navigation course, altitude and speed, and the flight simulator can be used to run the flight profile and automatically display the scenery outside the cockpit window and the instrument readings of the flight profile. The pilot can then fly the aircraft, which incorporates the system of the invention, and the data transmitted from the aircraft is displayed in a virtual display, which may be monitored by an instructor, for example, and/or recorded. The instructor thus has a reconstructed virtual view of the cockpit window according to the GPS and other data, linked with a 3D map of the terrain covered by the aircraft, and of the panel instruments, in real time, enabling the instructor to instruct the pilot, for example, by comparing the actual flight characteristics to those of the planned flight of the aforementioned simulator. Further, during the flight the instructor is able to compare, in real time, the actual course taken by the pilot with the preflight profile, providing the instructor with the capability of instructing the pilot regarding any deviation between the desired and actual flight path.

Optionally, the present invention allows for a grading system to be incorporated that provides a grade according to how the pilot performs with respect to the preflight profile, according to any suitable method of grading the differences between the actual course taken by the pilot and the preplanned flight profile. This further enables objective real time training and grading.

At the end of the flight the instructor may debrief the pilot, or the pilot may debrief himself. For this purpose, there may be two displays set up side by side, for example, one relating to the preflight profile, and the other to the actual flight. Accordingly, the pilot gains expertise quickly by being monitored by the instructor, who is checking the instrument readings and optionally the cockpit filed of view in real time, and also benefits from being able to compare the actual flight profile with the planned flight profile in a quantitative manner.

The integrated data acquisition and display system of the present invention may also be usefully applied to vehicles other than aircraft, for example land vehicles, sea faring vehicles, amphibious vehicles, hovercraft, and so on, as well as to static situations such as for example instrument panels of a power plant, and so on.

The integrated data acquisition and display system of the present invention may also be usefully applied to aircraft that already have flight recorders, as these recorders often do not record the readings of all the instruments. For example, the system of the present invention may be used to record the actual behavior of the engines, and this may be compared to nominal behavior for the same flight conditions using any suitable flight simulator, including spec conditions for the engines, as well as experience, for example. Any deviation between the actual and predicted behavior may be analyzed to predict a possible malfunction well before it fully develops, enabling corrective action to be taken. Presently, prevention of malfunction, where this exists, is by way of regular maintenance procedures.

In addition, by storing the design flight, it is possible for the system to automatically compare the actual flight with the preflight profile. If the deviation between the two is detected, it may be further analyzed to ascertain whether this deviation is placing the aircraft in an alert situation, which can then be promptly reported to the closest control tower, for example, so that action can be taken if necessary.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram exemplifying the general structure of the data acquisition system according to a first embodiment of the invention.

FIG. 2 is a block diagram exemplifying the general structure of the data display system according to a first embodiment of the invention.

FIG. 3 is a flow chart illustrating the data acquisition method of the invention according to one embodiment.

FIG. 4 illustrates an image that may be obtained using the system of FIG. 1.

FIG. 5 illustrates a marker that may be utilized as a datum for use in the system of FIG. 1.

FIG. 6 illustrates a part of the image of FIG. 4 relating to an instrument of an instrument panel.

FIG. 7 illustrates a data string obtained with the system of FIG. 1 and that may be transmitted to the system of FIG. 2.

FIG. 8 is a flow chart illustrating the data display method of the invention according to one embodiment.

FIG. 9 illustrates the general structure of the data acquisition system according to a second embodiment of the invention.

FIG. 10 illustrates the superposition of a real image and a virtual image obtained with the embodiment of FIG. 9.

FIG. 11 illustrates a composite image obtained with the system of FIG. 2, incorporating virtual images of the types illustrated in FIGS. 4 and 10.

FIG. 12 illustrates the general structure of the data acquisition system according to a third embodiment of the invention.

FIG. 13 illustrates an image of a Region of Interest (ROI) within an image of an instrument panel.

FIG. 14 illustrates the ROI of FIG. 13 in greater detail.

FIG. 15 illustrates the indicator of the ROI of FIG. 14 in greater detail.

FIG. 16 illustrates a R-θ image obtained by transforming the ROI image of FIG. 14.

FIGS. 17(a) to 17(d) illustrate various alternative configurations of the ROI of FIG. 14 comprising a single dial.

FIGS. 18(a) to 18(c) illustrate various steps in obtaining θ for each one of 2 dials of the same ROI image by stepped analysis of the corresponding R-θ image.

FIGS. 19(a) to 19(d) illustrate various steps in obtaining θ for each one of 3 dials of the same ROI image by stepped analysis of the corresponding R-θ image.

FIGS. 20(a) to 20(d) illustrate an ROI image and the variation in the R-θ image according to displacement of the center of rotation of the instrument needle along the horizontal x-direction.

FIGS. 21(a) to 21(d) illustrate various steps in obtaining θ for an attitude direction indicator type ROI image by stepped analysis of the ROI image and corresponding R-θ image.

FIG. 22 illustrates an ROI image for a horizontal situation indicator type ROI.

FIG. 23 illustrates an R-θ image obtained for the ROI image of FIG. 22; FIG. 23(a) illustrates a pixel intensity distribution that may be obtained at an R value in the image of FIG. 23.

FIG. 24 is a block diagram exemplifying the general structure of the data acquisition and display system according to another embodiment of the invention with respect to inputs thereto and output therefrom.

FIG. 25 illustrates schematically in greater detail the system of the embodiment of FIG. 24.

FIG. 26 illustrates schematically data flow paths associated with flight monitoring when the embodiment of FIG. 24 is in operation.

FIG. 27 illustrates schematically functionality of the system of the embodiment of FIG. 24.

FIG. 28 illustrates schematically functionality of the Airborne Segment module of the system of the embodiment of FIG. 24.

FIG. 29 illustrates schematically functionality of the Ground Segment module of the system of the embodiment of FIG. 24.

### DETAILED DESCRIPTION OF THE INVENTION

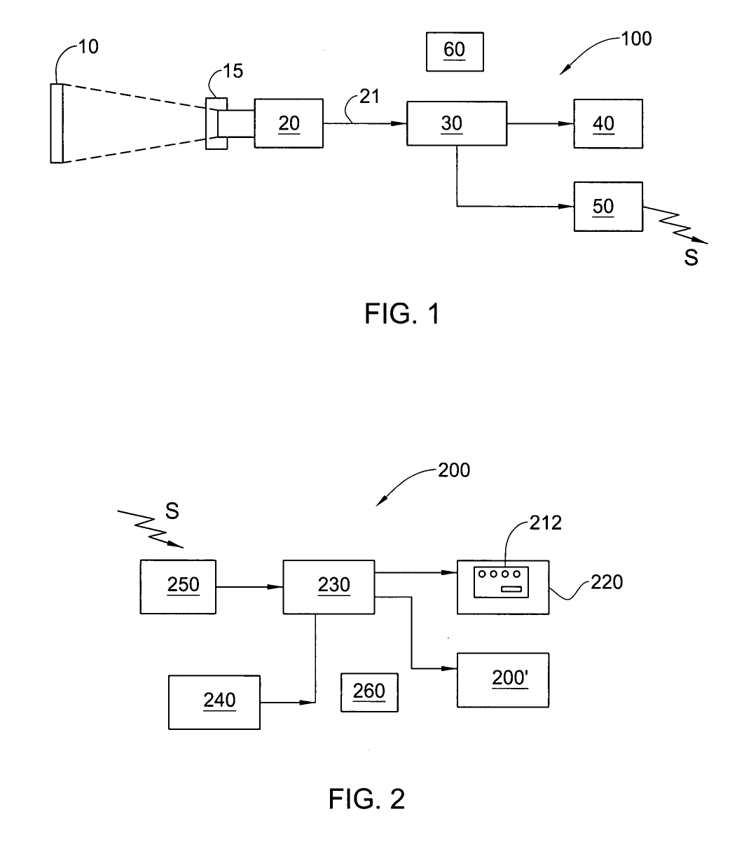

Referring to FIG. 1, in a first embodiment of the present invention, the data acquisition system, generally designated with the reference numeral 100, comprises at least one camera 20 operatively connected to a processing means such as a computer 30, which may be capable of processing images and other data, the system 100 being powered by a suitable power supply 60. The power supply 60 nay be a centralized power supply, supplying power to each component of the system, or may comprise individual power units, each powering one or more of the components of the system 100. The camera 20 is located at a suitable location such as to be able to optically capture the instruments 12 that of interest, and typically that form part of an instrument panel 10. A particular application of the invention is for the acquisition of real-time flight data for aircraft, for example private or trainer aircraft, and thus the camera 20, optionally fitted with a polarizing filter 15 that may be adapted for providing optimal reduction of some unwanted reflections, e.g. stray sunlight, is mounted in the cockpit at a position such that all the instruments of interest are within the field of view of the camera. Where this is not possible, or where it is desirable to, a number of cameras may be mounted in the cockpit, each camera capturing at least a part of the instrument panel 10: for example the cockpit may comprise two cameras pointing in the direction of the instrument panel, one on the right and one on the left of the pilot, to provide unobscured views of the whole panel. The images of the two or more cameras may be analysed separately, or alternatively the images may be suitably combined as a function of time, and then the composite images analyzed. In other embodiments, an additional spectral filter may be provided, which may be matched to an external light source that illuminates the instrument panel. If the spectral line is far enough from the sun's spectrum, then the contrast may be enhanced even in strong sun reflections.

In yet other embodiments, camera 20 may comprise a multiple knee-point camera, which enables the creation of Regions of Interest (ROI) in virtual space by the camera computer, each of which matches the positions of the instruments or gauges as viewed by the camera. To each ROI in this virtual space can be assigned a unique digital contrast technique that in real time reduces the effect of sunlight reflection to the required minimum. Such a camera may comprise e.g., the PLB741F camera, by PIXELINK (USA).

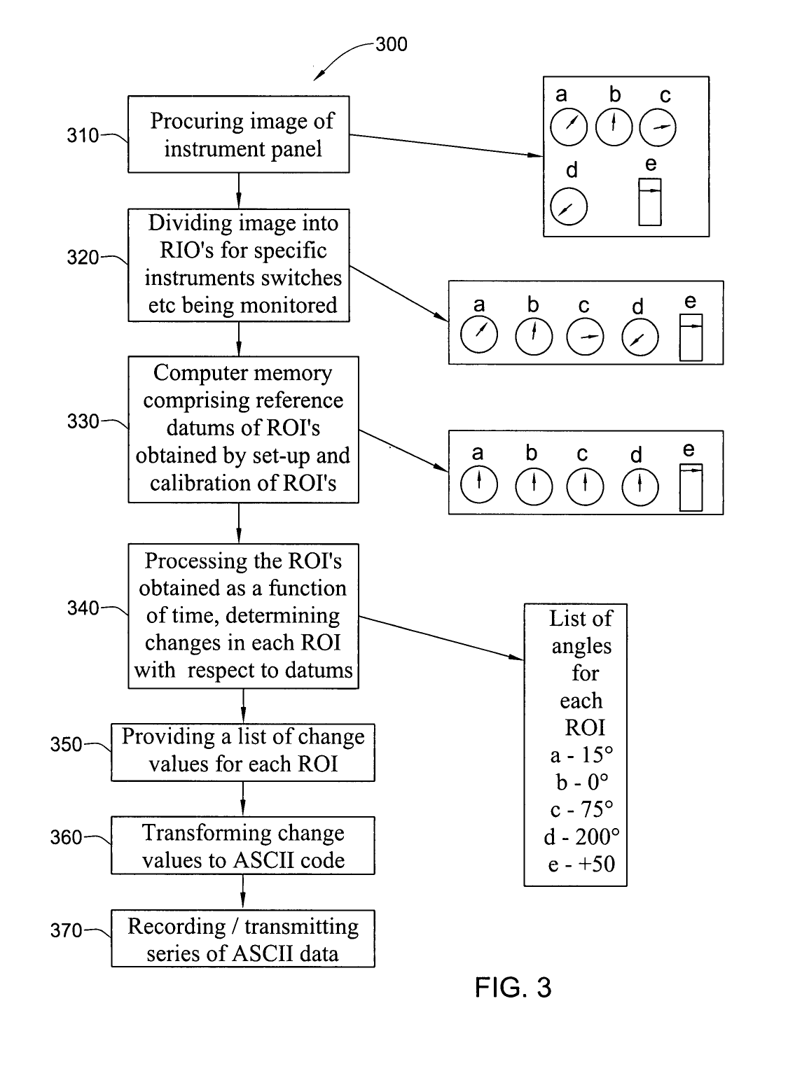

Referring to FIG. 3, the method 300 for acquiring data according to an embodiment of the invention, comprises the steps of:—

Step 310: Procuring at least one image of instrument panel.

Step 320: Dividing image into Regions of Interest (RIO's) for specific instruments, switches etc. being monitored.

Step 330: Providing a computer memory comprising reference datums of ROI's obtained by set-up and calibration of ROI's.

Step 340: Processing the ROI's obtained as a function of time, determining changes in each ROI with respect to datums.

Step 350: Providing a list of change values for each ROI.

Step 360: Transforming change values to a coded data stream, e.g., ASCII code.

Step 370: Recording/transmitting series of data, e.g. ASCII data.

Step 310 may be accomplished with the system 100, for example. The camera 20 is adapted for providing digital images 110 of the control panel 10, and may include any one of, a plurality of, or a combination of, regular video cameras, CCD cameras, infrared cameras, line scan cameras, and so on. One, and preferably a plurality of images may be taken by the camera 20. The camera 20 may provide a video digitizer unit (not shown) for processing successive video frames, and the digitizer unit sends digitized images 110 to the computer 30 via input 21. Each image may be stored in a frame buffer (not shown) in the computer 30 until processed thereby, as will be described further herein. Alternatively, the camera may transmit the digital images to the computer via any suitable means known in the art.

The digital image 110 for each frame (with respect to time) taken by camera 20 is processed by computer 30 according to the method of the invention.

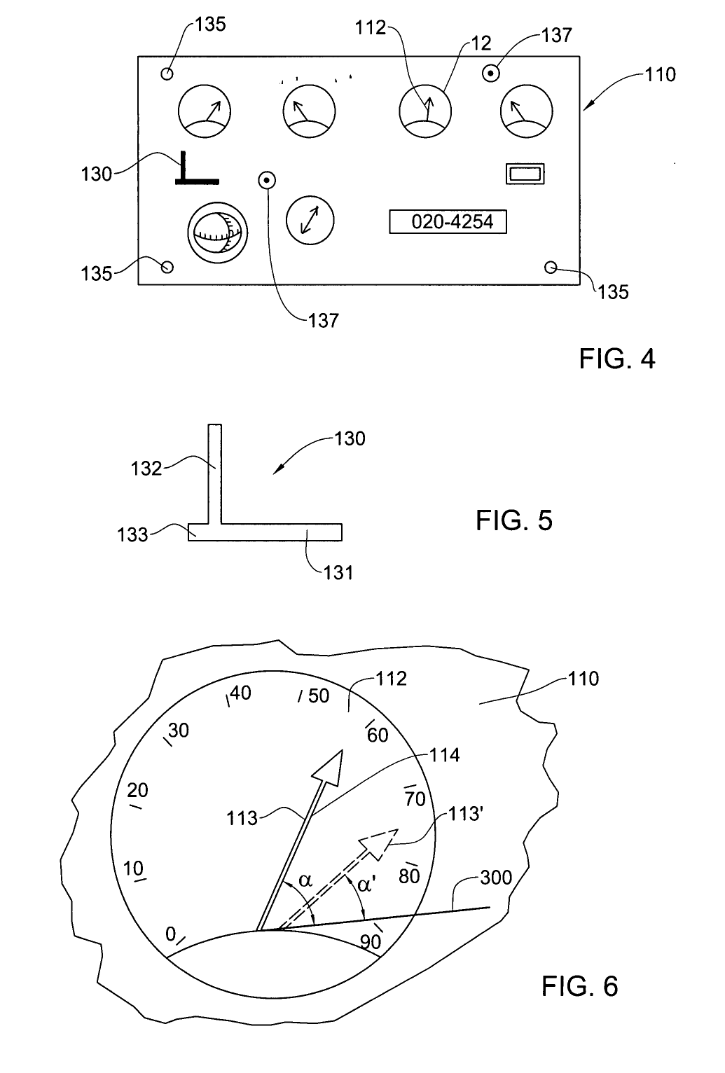

Referring to step 330, a datum is defined, preferably on the instrument panel 10, for referencing all the images captured by the camera 20. A suitable marker 130 can be provided on the instrument panel 10 for this purpose, as illustrated in FIGS. 4 and 5, for example. The marker 130 may comprise an L-shaped symbol, for example, having an arm 131 which is aligned horizontally with respect to the instrument panel, and a second arm 132 orthogonal to the first arm 131 and oriented vertically. The first arm may extend past the point of intersection with the second arm 132 to provide a minor arm 133. The shape of the marker 130 is thus unique, regardless of its orientation, and thus the orientation of the control panel 10 in any image obtained by the camera 20 can be precisely known from the position of the arms 131, 132, 133 of the marker within the image, even if there is relative movement between the camera and the panel. Furthermore, the use of the marker 130 does away with the need for very precisely aligning the camera with respect to the control panel. For greater accuracy, a pair of spaced markers, or a plurality of markers or other fiducials may be used. For example, three colored lights 135 or other easily identifiable points, spaced one from the other in a known arrangement on the control panel 10 can be used to provide a useful datum for the images 110, as illustrated in FIG. 4.

Optionally or additionally, two round markers 137 may be installed on the instrument panel such as to be visible to the camera 20. The markers 137 may each comprise an outer white annular ring surrounding a dark or black inner dot or circle, and provide a convenient reference system or fiducials, as well as a means for stabilizing the reference system. By comparing each frame taken by the camera with the previous frame with respect to these special markers, vibrations can be filtered out. The form of the marker 137, with a white ring around a black dot, allows for relatively simple and fast image processing.

In step 320, the system 100, in particular computer 30, enables the part 112 of the image 110 corresponding to each instrument 12 of interest to be separated from the main digital image 110. Typically, such a part 112 comprises the region of interest (ROI) for the particular instrument or switch being monitored. In particular, the portion 114 of this part 112 that is indicative of the reading of the instrument 12, as it appears in the captured image(s) 110, is identified and converted into a digital value that is correlated to this reading, as will be described in greater detail herein. For this purpose, the image 110 needs to be calibrated with respect to the computer 30. Such a calibration is referred to herein as a “laboratory calibration” which is performed, typically once, though may be updated as desired, and, the computer 30 may comprise in its memory a virtual model of the specific instrument panel 10, and thus be programmed to identify regions of interest with respect to this model, corresponding to the locations of instruments 12, referenced to the marker 113. Alternatively, the computer may be programmed to directly examine regions of each image 110 that are to be found at various locations in the image and spaced from the image of the marker 113 in a predetermined manner corresponding to the locations of the instruments 12 relative to marker 113. The computer 30 therefore has the specific geometrical and spatial characteristics of the marker 113 pre-programmed, according to the laboratory calibration, and is also programmed for identifying the image of such a marker 113 in any image 110 that is processed by the computer 30.

The camera 20 thus needs to be properly aligned with the panel 10 so that it may capture the ROI's of interest, which may include the whole panel in some cases. For this purpose, the position of the camera 20 may be adjusted in many different ways. For example, the position may be adjusted in a trial and error manner, by transmitting a video stream or still images to a ground station, and receiving feedback from a user monitoring the image at the ground station. Alternatively, the camera may comprise a viewfinder feed that is connected to a suitable portable display device, for example a small computer, a portable DVD player, or a digital camera, which are equipped or otherwise configured for displaying such a feed, for example. In other embodiments, a Palm computer or the like may also be configured to facilitate alignment between the camera and the panel, enabling user friendly installation and calibration of the camera.

Thus, the computer 30 works on the frame buffer in which the image 110 has been downloaded, and divides the image into a plurality of regions of interest (ROI), each corresponding to an instrument or switch being monitored, for example, using the reference markers 113 on the instrument panel. Dividing the image 110 into ROI's reduces the amount of processing of the image 110 to those regions specifically.

Optionally, the laboratory calibration may be such that the computer 20 may be programmed with a library of control panel configurations in a data base, and the appropriate configuration chosen according to the specific type of panel 10. Such a choice may be made manually, for example. Alternatively, an optical character recognition program may be adapted for comparing a datum image of the control panel with each configuration in the data base, and the best match with respect thereto is then chosen.

In step 340, the images of the ROI's 112 are processed corresponding to each time interval, i.e., with respect to each frame captured by the camera 20, to determine visual changes in the ROI's with respect to datums. Taking as an example a dial-type instrument, and referring to FIG. 6 in particular, the angle α of the image of the indicator, which is in the form of a pointer or needle 113 in the image 112 of instrument 12, with respect to a datum 300 and the center of rotation of the needle 113, are determined. The datum 300 is related in a known manner to the spatial disposition of the marker 130, for example, parallel to arm 131. Optionally, and preferably, this datum may correspond to the position of the needle 113 in the image 110 when the instrument is reading zero (or another datum or nominal reading), and thus the angle α is directly correlated with the angular displacement of the needle 113 from its zero position.

According to one aspect of the invention, a suitable optical character recognition (OCR) software can be adapted for this purpose, once it has been calibrated or programmed to recognize the image of needle 113 within the full frame image 110, in particular the particular region of interest, which typically comprises the image 112. The image of the needle is typically comprised of a plurality of pixels of a particular color or contrast in a linear arrangement for example, on a background of different color or contrast, and is thus easily recognizable by means of the computer. Thus, the readings of each instrument as seen on the image 110 are in the form of geometrically identifiable forms, each of which has a meaning according to predetermined criteria, and thus a digital sequence can be assigned to represent the meaning corresponding to each geometrical form that is recognized or identified by means of the computer. Typically, such geometrical forms are a line (corresponding to the needle 113) having a certain angle relative to a datum. The angle of this line has a predetermined meaning in that it represents the value of a particular parameter being displayed by a particular (typically analogue) instrument. In another example, an instrument may display the value of a parameter in alphanumeric form, and the computer identifies a standard alphanumeric character having a form or shape that most closely corresponds to the identified geometric form of the alphanumeric character in the image. A coded data stream, typically a particular digital sequence, representative of this parameter, is then created.

Suitable image recognition systems may include, for example, GeoTVision, provided by ATS (Israel). Since in general the location of the part 12 is known in the digital image 110, image enhancement techniques may be applied selectively to this part of the image to better identify the location of the needle 113, particular where the image resolution may not be high.

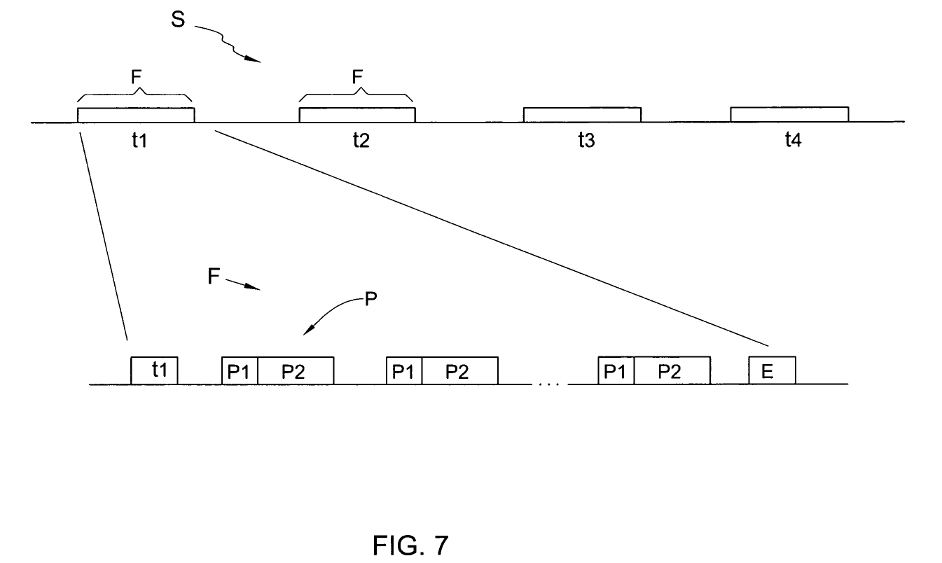

Thus, the angle α of needle 113 is determined in the image 110 with respect to marker 130, and then this angle is converted to a digital value P that is correlated with the magnitude of this angle, as illustrated in FIG. 7. At a successive time frame, the needle may have moved to position 113′, and thus to a new angle α″, as illustrated in FIG. 6.

In steps 350 and 360, the changes in the visual image for each ROI is determined and converted into a digital form. In one embodiment, the angular change in the dial of a dial-type instrument is determined, and this angular change is converted to a digital value, for example according to ASCII format. Similarly, the change in the position of a switch from a datum position can also be determined, and a digital value, such as for example according to ASCII, may be associated with such a change. Similarly, the changes in any other type of instrument or part of the instrument panel, or indeed of any other part of the environment captured by the camera 20, may be determined and converted to a digital output. In all such cases, the digital output relating to all the ROI's is muliplexed serially in a predetermined order, so that the digital value relating to each instrument or the like is readily identifiable in each string of values for any given time frame.

Thus, the encoded values of each instrument 12 may be determined, and the readings for all the instruments can be sent as a string of encoded data streams, for example ASCII characters, according to a pre-known particular order, which enables the instruments to which each reading corresponds to, to be easily identified.

Optionally, step 330 may be omitted, and the absolute values of the angles of the dials in each instrument may be transmitted in step 370. Reconstruction of the data by a receiving system 200 (see below) would take account of this change in procedure.

Alternatively, a digital value P may be encoded in a manner such as to identify this digital value as corresponding to a particular instrument 12 of the control panel 10. For example, and referring to FIG. 7, if the angular change for a particular instrument is 62.35°, a digital value P corresponding to the digits “03206235” can be created, wherein the first part P1 of P, i.e., digits “032”, is the code that identifies a particular instrument 12. The next part P2 of P refers to the value correlated to the parameter being measured: the next three digits “062” correspond to the value of the angle in hundreds, tens and units of degrees, respectively, and the last two digits “35” correspond to the value of the angle in tenths and hundredths of a degree, respectively.

Alternatively, the value of the angle α is converted into an ASCII character, and optionally an additional ASCII character representative of the instrument number is associated with the first ASCII character.

Alternatively, the readings provided by each ROI or instrument 12 may be calibrated, so that any particular angle of needle 113 can be converted directly into a digital reading. For example, an angle of 62.35° in a particular instrument 12 can correspond to an altitude reading of 4,950 meters, and the digital value “032004950” may be created to signify that the reading of instrument “032” was 004950 (meters).

Optionally, the computer can compare the digital value corresponding to an ROI or the reading on a particular instrument 12 with a successive digital value, obtained from a digital image taken at a time t2 after the previous image (taken at time t1). According to predetermined criteria, if the subsequent digital value is considered unchanged from the earlier value (for example, within ±3% of one another), the subsequent digital value may be encoded such as to signify that there is no change from the previous value, rather than providing the actual value. For example, a coded digital value “03299” may refer to instrument no. “032”, and the digits “99” signify no significant change from the previous value.

Alternatively, the changes in angle α between successive images may be converted to a digital value, and these encoded in a similar manner as described herein for the full magnitude of the angle α, mutatis mutandis. These digital values that are correlated to the changes in angle α can be referred to a baseline absolute value of angle α, which can be defined for the first digital image, for example.

Other instruments in the control panel 10 may comprise an alphanumeric character output, for example, and the computer 30 can similarly isolate the part of the image 110 containing this instrument, and use OCR techniques to recognize these characters. Once the characters have been recognized, digital equivalents of the characters may be created, and optionally encoded with the instrument identification in a similar manner to the dial instrument readings described above, mutatis mutandis.

Similarly, the position or status of switches, knobs, levers and any other control or data device or apparatus in the image 110 can be optically identified and compared to a datum position or value, and the changes converted to digital values and optionally encoded from the image 110 in a manner similar to that described herein for a dial-type instrument, mutatis mutandis. For this purpose it may be convenient to define secondary regions of interest comprising such switches, etc., which may be sampled at a different rate to the instruments 12, for example, or concurrently therewith. For example, it may be desired to check the instruments every 0.05 seconds, but the position of switches every 2 minutes to check whether any changes have occurred in these settings.

Other types of instruments can also be read in a similar manner. For example a horizon sensor, or an instrument display in the form of a bar, the length of which represent a quantity being measured, and the readings are separated and optionally encoded from the image 110 in a manner similar to that described herein for a dial-type instrument, mutatis mutandis.

The sampling rate for camera 20, i.e., the frequency with which successive digital images 110 are taken, may be fixed or variable. For example, the rate may be fixed at 0.01, 0.1, 0.25, 0.5, 1, 5, 10, 20, 30 or 60 second intervals, or any value therebetween, or at any other value less than 0.01 seconds or greater than 60 seconds, as may be required. Alternatively, the sampling rate may be linked, for example, to the rate of change of one or a more parameters being measured by the instruments 12. Thus, for example, the computer 30 compares the digital values for such instruments between the last two successive images. According to the magnitude of the changes in these digital values, the time interval for the next image acquisition may be shorter or longer. For example, if the changes in a critical parameter, such as air speed exceed a certain threshold value, then the acquisition rate is increased accordingly. The threshold may also be varied, for example, as a function of the absolute value of one or more of the parameters. For example, if the air speed is close to the stalling speed, then the threshold is lowered, so that even smaller changes in speed cause the sampling rate to be increased.

Thus, for each visual frame or image 110, the optical data provided by camera 20 is filtered and processed to provide flight data, F, in the form of a string of digital values P. Each digital value P explicitly (via coding for example) or implicitly (by position in a series of values, for example) identifies uniquely an instrument 12 of panel 10, and provides a measure of the reading provided by this instrument. A time value t can also be included in data F, to identify the time, in relative or absolute terms, when the image was taken. A suitable end marker E encodes the end of the data string for the data F. The data F for a plurality of successive images may be comprised in a global data set S.

In step 370 the digital values obtained from the ROI's are transmitted and/or recorded, in real time or in any other desired manner.

For example, the data set S may be stored in memory 40, which can optionally be adapted to act as a crash survivable device, and thus enable such data S to be recovered in case of a crash. The data set S thus represents the useful data of each frame 110 over a period of time in a highly compressed, and optionally processed form. For this purpose, the computer may be programmed to retain only the preceding 30 minutes of data, for example, deleting old data from the memory 40 that is older than 30 minutes, as new data is input thereto.

According to the invention, the data S is preferably transmitted via transmitter 50, such as for example an RF transmitter, in addition to or instead of being recorded in memory 40. Transmitter 50 comprises any suitable transmission means that may transmit the data S. Thus, transmitter 50 may comprise, for example, a radio transmitter, or a cellular phone arrangement, or satellite communication module. Where transmitter 50 is a radio transmitter, this may be the regular aircraft radio, or may be a dedicated radio transmitter. In any case, the digital data transmitted by the transmitter can be of extremely low bandwidth, since only a few bits are sufficient to define the status of each instrument, and is thus relatively inexpensive relative to the cost of a light trainer aircraft, for example. A two-way radio, or a dedicated radio may often be preferable, since this allows the data S to be transmitted in a continuous manner in discrete packages of digital data, each package corresponding to an image taken by camera 20, while the pilot may be communicating verbally with an instructor, for example.

Particularly when the system 100 is installed for operation such as in a trainer aircraft, and therefore according to practice should remain within a reasonable radius from the home runway, say 10 kilometers, the transmitter 50 only requires to have a range of up to or a little over 10 km. The range of transmitter 50 will generally depend on the specific application of the system 100. For example, a small civil aircraft can have a radio having range of 10-20 km, and suitable radios for this purpose are provided by Aromid (Beer Sheva, Israel) or Motorola International (Israel), for example. In some applications, the transmitter may transmit data S to a satellite, which then directs the data to a ground station of choice. Alternatively, a ground relay system may be used for relaying the data received at any one receiving station to a central station, and thence to a desired station or plurality of stations, or directly to the desired station(s). For systems 100 that are adapted for uses in static structures, for example for monitoring the instruments at a power plant, the transmitter 50 may be adapted to transmit the data S along a land line, or other communication means such as the Internet, a telephone communication system, an intranet, cellular phone network, or any other suitable communication medium.

According to another aspect of the invention, a novel per se method and system is provided for identifying an angular disposition of an instrument indicator, such as a pointer for example, in instruments that display data in analog angular form, i.e., where the angle of the indicator, which may comprise for example a pointer and/or characters and/or other symbol or marker, relative to a datum and center of rotation is a measure of the value of a parameter being displayed by the instrument. According to this aspect of the invention, such identification is performed in a manner that is different from OCR based methods, and which is generally relatively faster and more efficient, requiring minimal computing time.

The natural representation of the ROI in the computer is an array of pixels, generally arranged along orthogonal axes, say x and y. However, when it is desired to determine angular information of a line of pixels at an angle to these axes, it is a time consuming process to apply known processing or character recognition techniques with respect to these axes to directly determine such angles. In some embodiments of the present invention, and as will be described in greater detail, a look-up table may be provided relating the position of the pixels relative to the x, y axes to equivalent R (radius) and θ (angular disposition), and the desired angle determined with a minimum of calculation, and therefore processing effort.

According to this aspect of the invention, the steps 330 and 340 of method 300 are respectively directed at providing a calibration for determining the center of rotation of a dial-type display comprised in the ROI, and determining the angular disposition of the pointer and/or characters and/or other symbol or marker corresponding to the value of the parameter being displayed by the display.

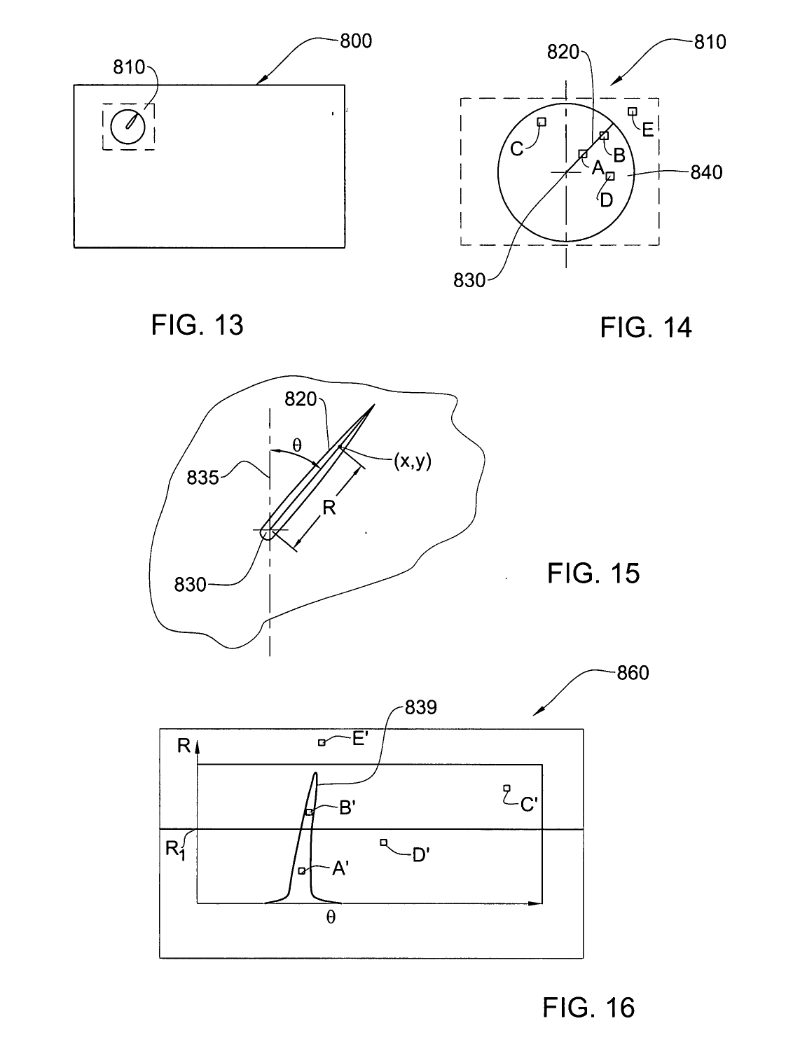

According to one embodiment of the invention, and referring to FIGS. 13 and 14, the particular ROI image 810 provided from the ROI being monitored on instrument panel 800 comprises a dial-type display, including a pointer 820 that rotates about a center 830 on instrument face 840. Once the ROI image 810 has been identified (step 320) for the dial instrument, the center of rotation 830 of the pointer 820 is determined. This is generally a field calibration step that may be performed prior to taking readings, for example at the beginning of each data acquisition session, for example prior to a flight of an aircraft incorporating the system of the invention. The calibration step will be explained in more detail below.

The next sub-step of step 340 according to this embodiment comprises executing a transformation of the ROI image 810, so that the angular relationship of the pointer 820 (and/or characters and/or other symbol or marker, mutatis mutandis) with respect to the face 840 is transformed into a Cartesian type relationship in a reconstructed image.

Referring to FIG. 15 in particular, each pixel or other image element in the ROI image can be described in terms of a (R, θ) set of coordinates, according to its angular disposition (angle θ) about center 830 with respect to a datum, for example a vertical line 835 (or indeed any other line of known orientation), and distance (radius R) from the center 830. Referring to FIG. 16, the (R, θ) coordinates can then be plotted on Cartesian axes, θ along horizontal axis and R along the vertical axis, for example, to form an R-θ image 860.

Although the (R, θ) coordinates may be calculated for each pixel or other image element each time, according to the invention other methods are provided that enable the transformation to be executed faster. For example, while it is possible to attribute (R, θ) coordinates to each pixel of the ROI image once the center of rotation 830 is known, it is also possible to assign (x, y) Cartesian coordinates for the location of each pixel or image element with respect to the ROI image itself. Accordingly, each (x, y) position on the ROI image may be directly converted to a (R, θ) position on the R-θ image, given the position of the center of rotation 830, and a simple look-up table may be provided, for example, to assign values of (R, θ) to each pixel position (x, y), once the center 830 is known. Accordingly, the R-θ image may be constructed created very rapidly without the need for complex calculations. Thus, and as illustrated in FIGS. 14 and 16 by way of example, pixels A, B, on pointer 820, pixels C, D on face 840, and pixel E outside the face 840 in ROI image 810 are transformed to the positions A′, B′, C′, D′, E′, respectively, of the R-θ image 860 shown in FIG. 16.

Thus, effectively, in the R-θ image, the pixels of the ROI image are re-arranged with respect to orthogonal axes which now represent the radius R and angle θ of the pixel locations relative to the center 830. Thus, as illustrated in FIG. 16, the pointer 830 now appears in a distorted manner, as indicated at 839, in the form of a substantially symmetrical spike having a relatively wide base and which is vertically centered about a particular angle θ along the θ-axis.

It is to be noted that, for this and other embodiments, the R-θ image does not necessarily have to be a displayed image per se, and it may often be sufficient for the data that is representative of the R-θ image exist within the virtual space of the computer, so that it may be manipulated to provide the information required, regarding the angular and/or radial position of the pointer. Accordingly, by “R-θ image” is meant herein to include a real image as well as data representative of an image that may exist in the memory or the like of a computer, for example.

In the next processing step, undertaken by the computer 30 of system 100, the position of the transformed pointer image 839 is determined along the θ-axis, and this is also a relatively simple and fast operation. For example, a line of pixels at a particular R value, R1, on the R-axis may be scanned along the θ-direction to check for a significant change in the value of a parameter associated with the pixels, for example the color, intensity, etc of the pixels, to the value of this parameter associated with the image of the pointer. For example, the pointer image 839 may appear white on a black background associated with the face 840, and thus when the scan encounters white pixels along the aforesaid line of pixels, the position of the pointer image 839 along the θ axis is identified. Optionally, this procedure may be repeated for a plurality of adjacent and/or spaced lines of pixels each line representing along one of a plurality of R values on the R-axis, and the position of the pointer image 839 along the θ axis may be compiled by suitably collating the results for each line of pixels—for example by averaging the value of θ obtained.

The pointer image 839 may have a finite thickness of more than one pixel, and thus a group of pixels will be found associated with the change in the aforesaid parameter. In such a case, the value of θ corresponding to the middle pixel of the group of pixels may be chosen to provide the value of θ for the pointer. Alternatively, the value of this parameter may be plotted with respect to the corresponding value of θ, and the value of θ corresponding to the pointer 839 chosen where the value of this parameter peaks, enabling the value of θ to be calculated to sub-pixel accuracy.

Other methods may be employed to obtain a nominal value for θ corresponding to the position of the pointer image 839 from the variation in the parameter with respect to θ. For example, the edge of the pointer image 839 provides an indication of the position of the pointer. This edge may be found in a relatively simple manner by obtaining the intensity of the pixels in the line of pixels being scanned, and applying the following formula to obtain a derivative G for each successive pair of pixels j, k:—
G=[I(θⱼ)−I(θₖ)]/(θⱼ−θₖ)

wherein I(θⱼ) and I(θₖ) are the pixel intensities corresponding to the ROI image at angles θⱼ and θₖ, respectively, which may have a value of 0 or 1, depending, for example, whether the pixel corresponds to the pointer or instrument background. Thus, as the line of pixels is scanned the derivative G will have a non-zero value wherever an edge is encountered. The computational time may be further reduced by simply comparing the value of the pixel intensity with the value of the previous pixel, and determining when there is a change.

In this manner the position of the pointer 830, i.e., the deflection angle θ thereof with respect to the ROI image 810, may be found in a fast and efficient manner that does not require complex computations such as are associated with known OCR techniques.

The above methodology for obtaining the desired angle associated with a pointer may be further simplified, thereby further reducing computing time.

For example, assuming that the ROI is a circle having a known center, the radius of the circle being that of the outermost ring scale of the instrument being represented by the ROI, the ROI can be considered in terms of local x, y Cartesian coordinates with the circle center as the origin, rather than in terms of its global coordinates with respect to the panel image. Thus, the edge of the ROI circle may be considered to extend between +a and −a along the x-axis, and between +b and −b along the y-axis, for example. In other words, any pixel may be first represented by a local coordinate system based on the width (2*a) and height (2*b) of the ROI, and the global coordinates of the pixel with respect to the panel converted to local coordinates with respect to the ROI.

Accordingly, any pixel in the ROI will have (x, y) coordinates which can be first represented by:—
−a<x<0 −b<y<0
+a>x>0 +b>y>0

However, rather than convert all the (x, y) pixel positions to (R, θ) positions, the computing time may be significantly reduced by only converting the pixels that fall within an annulus in the ROI that corresponds to the one or more R-values that it is intended to scan along the θ direction. Thus, the ROI may be set to conform to the specific areas of interest within it, and effectively ignores the remainder of the image, correspondingly reducing the computing time and effort.

Additionally or alternatively, the value of θ equivalent to a particular (x, y) position may be found using the following methodology. The ROI may be divided into 8 equal sectors, each of 45 degrees, and a coefficient K is assigned to each sector, as follows:

Sector (a)

If x>y, and x>0, and y>0

Then, θ is between 0° and 45°, and K=0

Sector (b)

If x<y, and x>0, and y>0

Then, θ is between 45° and 90°, and K=1

Sector (c)

If x<y, and x<0, and y>0

Then, θ is between 90° and 135°, and K=2

Sector (d)

If x>y, and x<0, and y>0

Then, θ is between 135° and 180°, and K=3

Sector (e)

If x>y, and x<0, and y<0

Then, θ is between 180° and 225°, and K=4

Sector (f)

If x<y, and x<0, and y<0

Then, θ is between 225° and 270°, and K=5

Sector (g)

If x<y, and x>0, and y<0

Then, θ is between 270° and 315°, and K=6

Sector (h)

If x>y, and x>0, and y<0

Then, θ is between 315° and 360°, and K=7

Knowing the (x, y) coordinates of each pixel in the ROI automatically provides a value for K according to whether x is less or greater than y, and whether each of x and y is less or greater than zero. The angular position, θᵢ, of a particular pixel “i” is then found by the following simple transformation:—
θ=arc tan(|xᵢ|/|yᵢ|)+K*45

where |xᵢ| is the modulus or absolute value of the x-coordinate of the pixel “i”, and |yᵢ| is the modulus or absolute value of the y-coordinate of the pixel “i”.

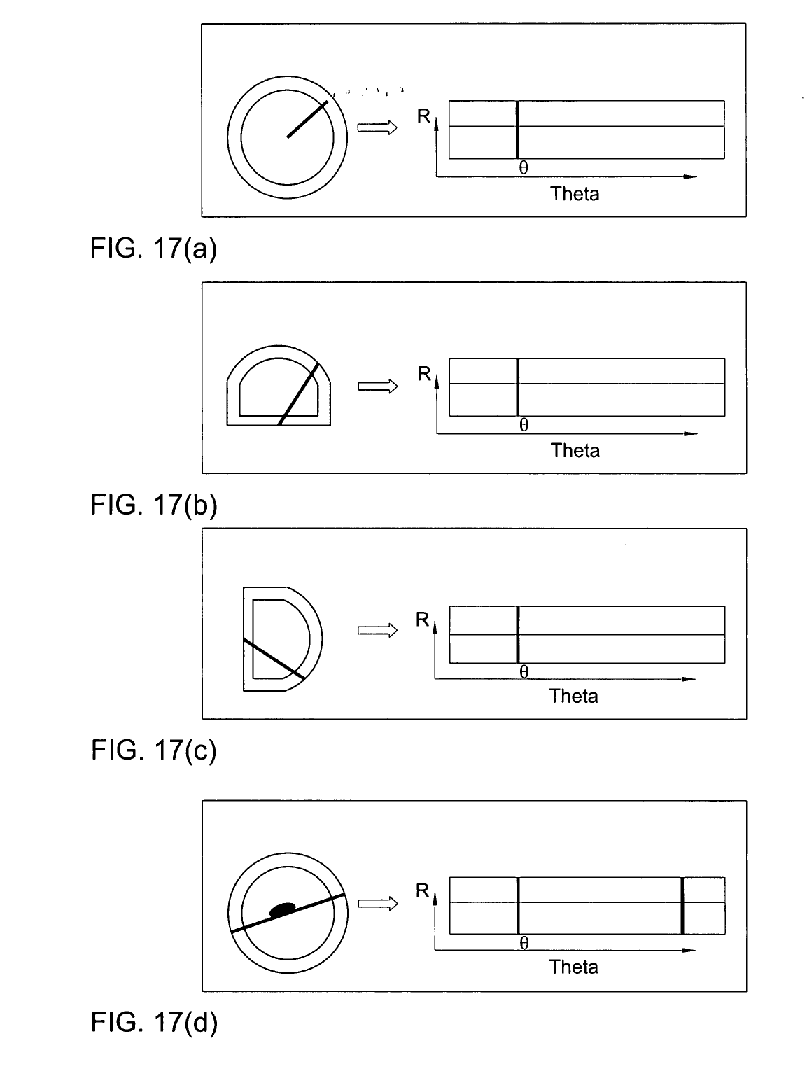

The above transformation method may be applied to many different types of instruments having a single dial. For example, and referring to FIG. 17(a), the ROI may comprise a full 3600 face, in which the dial may be expected to rotate the full 3600, or a substantial portion thereof, for example RPM gauges, speed gauges and so on.

Alternatively, and referring to FIG. 17(b), the ROI may comprise a half-circle face or the like (for example forming a sector of a circle of any desired angular size), in which the dial may be expected to rotate about a limited range of angles, substantially centered on a vertical centerline, for example, and the datum may comprise the zero setting which may be, for example, at an angle to the vertical. Such ROI's may include, by way of example, EGT gauges, oil pressure gauges, and so on. Alternatively, and as illustrated in FIG. 17(c), the half-circle face may be oriented so that limited range of angles is substantially centered on a horizontal centerline, and may include, for example, fuel gauges and so on.

Referring to FIG. 17(d), the ROI may comprise a diametric pointer, rather than a radial pointer, and thus two diametrically opposed values of angle θ may be concurrently obtained in the transformation R-θ image. Examples of such ROI include turn rate gauges and the like. In this case, two θ values are obtained and optionally further manipulated as required.

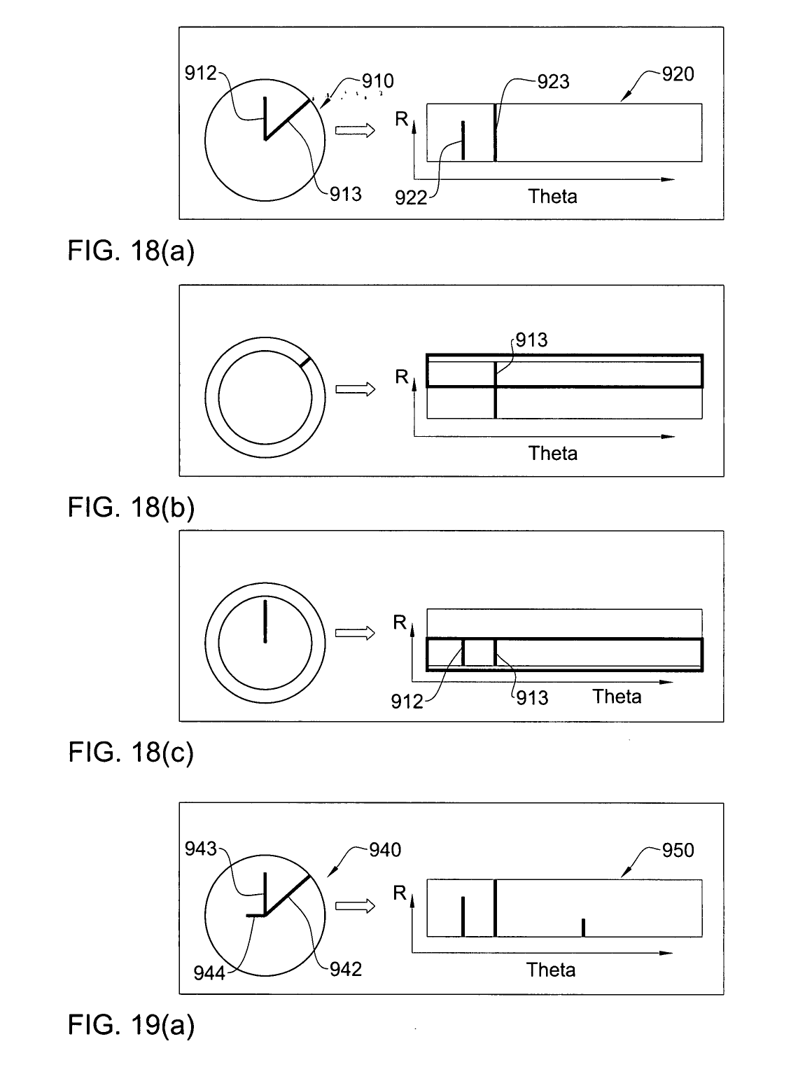

The above method may also be extended, mutatis mutandis, to ROI's comprising more than one dial or pointer. For example, and referring to FIGS. 18(a) to 18(c), an ROI image 910 comprising two pointers 912, 913 (for example as used in altitude gauges) is transformed into a R-θ image 920, in substantially the same manner as described above in connection with FIGS. 14 to 16, mutatis mutandis, the main difference being that in the R-θ image 920, there will be two peaks, 922, 923, corresponding to pointers 912, 913, respectively. The pointers 912, 913 are visually distinguishable one from another in one or more ways. In the illustrated example, pointer 912 is shorter than pointer 913, and the location of each pointer along the θ axis in the image 920 may be found by first scanning for the position of the longer pointer 913 at a value of R that is known to include only this pointer, and thus exclude pointer 912 (FIG. 18(b)). This may be done substantially as described with reference to FIG. 16, mutatis mutandis. Then, one or a plurality of pixel lines is scanned at corresponding R values that are within the length of the shorter pointer 912, and two values of θ should be obtained, one for each of the pointers 912, 913. As the θ-location of the longer pointer 913 is already known, the θ-position of the shorter pointer 912 may be determined by a process of elimination. If only a single value of the angle θ is obtained in the second scan, it may be assumed that both pointers 912, 913 are at the same θ-position.

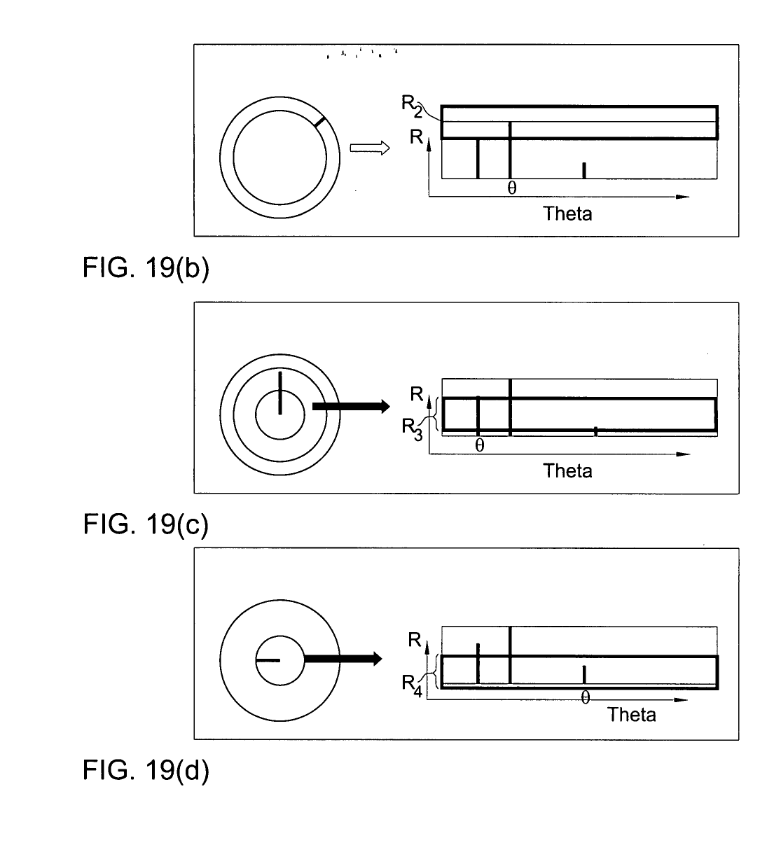

As illustrated in FIGS. 19(a) to 19(d), the method may be extended to an ROI image 940 comprising three dials, 942, 943, 944 of unequal lengths, mutatis mutandis, for example relating to an altitude gauge or the like. First, the R-θ image 950 is created in a similar manner as described previously, and then the θ-position of the longest pointer 942 is found by scanning one or more lines of pixels at corresponding R values within a range R2 that is greater than the lengths of the intermediate pointer 934 and of the small pointer 944. Next, the position of the intermediate pointer is found by scanning one or more lines of pixels at corresponding R values within a range R3 that is greater than the length of the small pointer 944, but less than the lower limit of R2, and the known position of 942 is removed from the two values of θ obtained (FIG. 19(c)). Lastly, the θ-position of the smallest pointer is found by scanning one or more lines of pixels at corresponding R values within a range R4 that is less than the lower limit of R3, i.e., that only includes the smaller pointer 944, and the known positions of 942 and 943 are removed from the three values of θ obtained (FIG. 19(d)). If only a single value of the θ is obtained in the second or third scan, it may be assumed that both pointers 942, 943, or all three pointers 942, 943, 944, respectively, are at the same θ-position.

Similarly, the method may be extended to ROI's having any number of pointers, mutatis mutandis.

Alternatively, the two, three or more pointers of a particular ROI image may be of different colors one from the other, and/or of different widths, in addition to or instead of being of different radial lengths. In such cases, the θ-location of each pointer may be obtained in a single scan by identifying the position in the R-θ image where the pixels have the color corresponding to the pointers, and/or, where there is a range along the θ-direction of particular intensity, color etc corresponding to the presence of a pointer, the range corresponding to the thickness of the particular pointer. In cases where the scan does not reveal pixels of the particular colors expected and/or in the range expected, it is possible that some or all of the pointers are in overlapping relationship, and thus have the same θ-position.

As indicated earlier, prior to creating the R-θ image for determining the angle θ of the pointer, the proper center of rotation 830 of the pointer needs to be calibrated. A number of different methods may be used for this in step 330, for example as will be described in detail below.

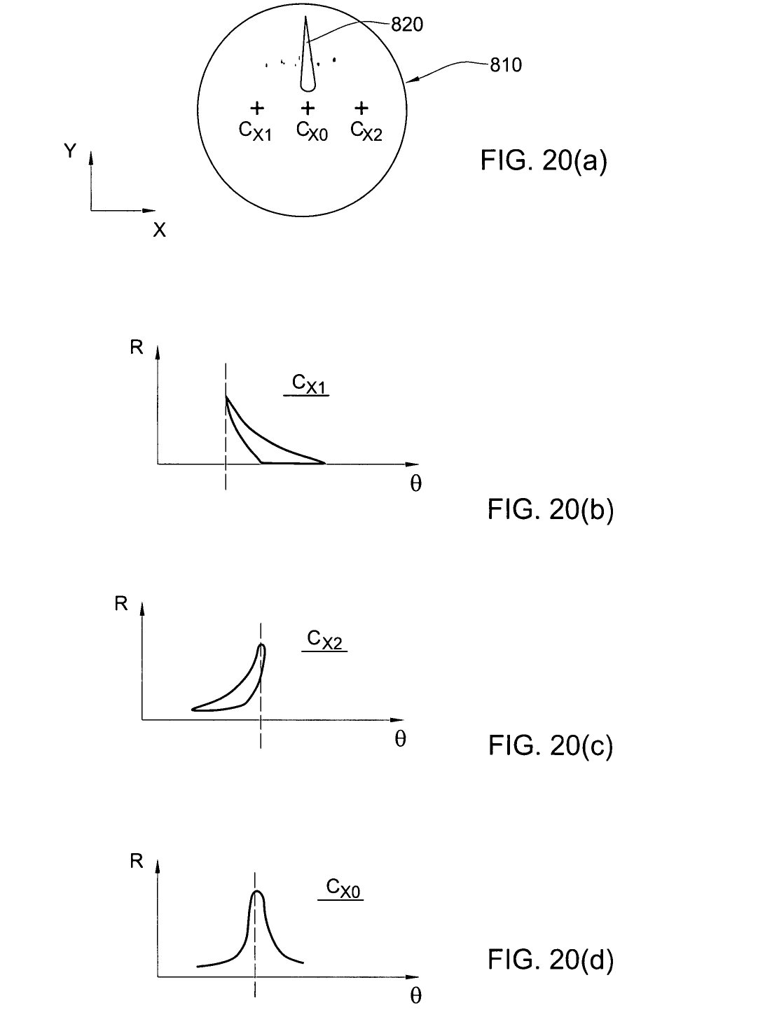

Optionally, an edge detection algorithm may be employed for detecting the edge of the ROI corresponding to the face of the instrument, for example, and a suitable method may then be used for fitting a closed curve thereon (or part of a curve according to the type of instrument), and for finding the center of the circle, say C_{X1} in FIG. 20(a). For dials where it is known that they are circular (or comprise part of a circle), the detected curve can be transformed to a circle (or part thereof) using any one of many known geometric transformations, and thus, the transformation is used to transform the whole image such that the curve is transformed to a circle (or part thereof).

Dials typically have a number of concentric circles (or parts thereof) associated therewith—for example the outer edge of the instrument, an inner circle defining angular gradations of the parameter being measured, etc. The next steps of calibration and/or of determining the reading of the dial can be performed on this transformed image.

The edge of the ROI image may fail to conform to a perfect circle in the image thereof for various reasons, including, for example, camera induced distortions such as originate when the camera optical axis is not exactly orthogonal to the particular dial being imaged, and/or perspective effects due to the relative wide angle lenses that are required given the proximity of the camera to the instrument and the relatively large field of view often required.

For example, a polynomial function P(x, y) may be used for describing the edge of the ROI, given by the expression:
P(x,y)=ΣᵢⱼPᵢⱼ(xⁱ,yⁱ)

The geometrical form of the polynomial P(x, y) may then be compared with the actual shape of the instrument (typically a circle) by matching corresponding points between the polynomial curve and the actual shape. Any number of points may be used, and the greater the distortion of the polynomial geometrical form with respect to the actual shape, the greater the number of points that may preferably be used. Then, having determined the relative spatial displacement of each point of the polynomial with respect to the actual shape, a suitable transformation algorithm may be applied to enable transformation of all the image elements (e.g., pixels) such as would transform the shape of the edge in the ROI image to the actual shape (typically the circular form) of the instrument.

This step may be done manually, for example as an interactive procedure, and may be completed as a factory calibration for particular position of a camera with respect to a particular instrument panel. The polynomial fitting and subsequent transformation may be performed for each instrument image in turn, or alternatively, once the transformation has been done for one instrument, the transformation is then applied globally to the whole instrument panel, and thus to the other ROI's in the same manner.

Once the transformation provides a transformed ROI that is a nominal or “perfect” circle (or part thereof), it is a straightforward matter to find the center thereof. On the other hand, if the transformed ROI image is not a “perfect” circle, as may sometimes happen if a global transformation is applied to the instrument panel, for example, then other methods may need to be applied to find the center of rotation of the instrument pointer.

For example, and according to one embodiment of the center calibration method in step 330, the center 830 may be independently calibrated along two orthogonal axes with respect to the ROI image 810 in a two stage approach, the order of which may be interchanged.

Then, or in the absence of carrying out the edge detection and transformation step, and with the pointer 820 pointing in a vertical direction, aligned with respect to one of the calibration axes, axis y, the ROI image 810 is transformed to a R-θ image with respect to the center C_{X1}, illustrated in FIG. 20(b). As may be seen, with the center C_{X1} actually offset to the left with respect to the real center C_{X0}, the image of the pointer 820′ is distorted to the right with severe asymmetry with respect to the real shape of the pointer 820, which in this example is in the form of a symmetrical triangle. In the next step, the center C_{X1} is moved to the right and a new R-θ image is created with respect to the new center. If the new center is now to the right of the real center C_{X0}, say position C_{X2}, the image of the pointer 820″ in the R-θ image will be distorted to the left (FIG. 20(c)). Accordingly, the position of the center may be moved in the x-direction (positive and negative) until a position is found, C_{X0}, in which the pointer image 820′″ in the R-θ image is symmetrical, as illustrated in FIG. 20(d). These iterations may be done interactively, with the user inputting a new position for the center each time, or alternatively automatically via the system 100, which for this purpose comprises suitable software programmed in the computer 30 for analyzing the shape of the pointer image in the R-θ image, and for determining the next shift in the center position until the symmetry of the pointer image is within a predetermined threshold. One relatively simple method of determining the degree of asymmetry of the pointer image in the R-θ image is by determining the θ-position for the pointer image at two spaced values of R—the closer the resulting values of θ are to one another, the more symmetrical the pointer image is.

Once the position of the center in the x-direction has been found, the pointer 820 may be rotated to a position aligned with the x-axis, and a similar procedure as described above for C_{X0} may be implemented, mutatis mutandis, for finding the center of rotation in the y-direction, C_{Y0}.

Thus, there are a number of calibration procedures for the ROI's, which may be summarized as follows:

(A) Main Calibration Procedure

This may typically be performed at the manufacturer, and takes into account the relative intended position for the camera with respect to the instrument panel, and is therefore required when using the system of the invention with a new instrument panel (for example a new aircraft) and/or when it is desired to move the camera to a position that is very different from the existing position (regarding which there may already be a factory calibration). The following steps may be performed:

Step 1˜The calibration starts with applying an image processing algorithm, for example an edge enhancement or detection algorithm, to determine the shape of an edge of an ROI in the image taken by the camera.

Step 2˜After applying this algorithm to the image of the instrument panel, a second algorithm is applied to separate each of the ROI's in the image that correspond to the instruments of interest.

Step 3˜Using predetermined criteria, for example criteria on symmetry, the extent of distortion is determined between the shape of at least one ROI and the real shape of the corresponding instrument.

Step 4˜If the distortion in Step 3 is larger than a predefined threshold, a transformation is applied to the ROI image (or to the full image of the panel) to obtain a transformed ROT image (or a plurality of transformed ROI images of the full panel), to get full or nominal symmetry in the ROI(s).

Step 5˜A centre finding algorithm is applied to each transformed ROI image to find the centers thereof.

Step 6˜The position of the centers of the transformed ROI's are related to the fiducial marks on the instrument panel, which serves to stabilize the data acquisition process from frame to frame, even when there is vibration of the camera and/or panel.

Step 7˜For each transformed ROI image, an (x, y) to (R, θ) transformation is carried out, either for the whole ROI image or for selected parts thereof (for example an annular part of the image at a particular R value), and the symmetry of the instrument pointer in the R-θ image is checked. If necessary the center of the ROI image may be adjusted as necessary to correct any asymmetry (assuming the real shape of the pointer is symmetrical), which may be an automated process.

Step 8˜The optimal part of each transformed ROI is then chosen for instrument dial—for example an annular portion of the image at a particular radius from the center, and so on.

Step 9˜The particular transformations may then be stored in the computer 30 for future use during operation of the system of the invention.

(B) First Use Calibration Procedure

Typically, a user may receive the data acquisition system of the invention after the Main Calibration Procedure has been completed at the factory, for example as described above. In this case, when the system is first used by the user, there may be some differences in the spatial relationship between the camera and instrument panel, for example, and may require a further calibration when installed. This calibration procedure may be fully automatic, for example, and may involve the system checking how close the transformed ROI's obtained with the system camera are to their respective nominal actual shapes, and modifying the transformations so that the ROI are transformed into the correctly shaped images.

(C) Calibration at Each Subsequent Use of the System

In regular operation, the data acquisition system matches the ROI images at positions according to the position of the fiducial markers on the images, and thus compensates for vibrations or other small movements between the camera and instrument panel.

Alternatively, the Main Calibration Procedure may be based on an analytical procedure rather than as described above. For example the relative spatial positions and orientations of the camera and instrument panel may be analyzed, and the extent and nature of the distortion of an ROI image may be calculated with respect to the actual shape thereof. Then, a transformation algorithm may be formulated to transform original ROI images to transformed ROI images so that the latter are in nominally circular form corresponding to the actual form of the instruments.

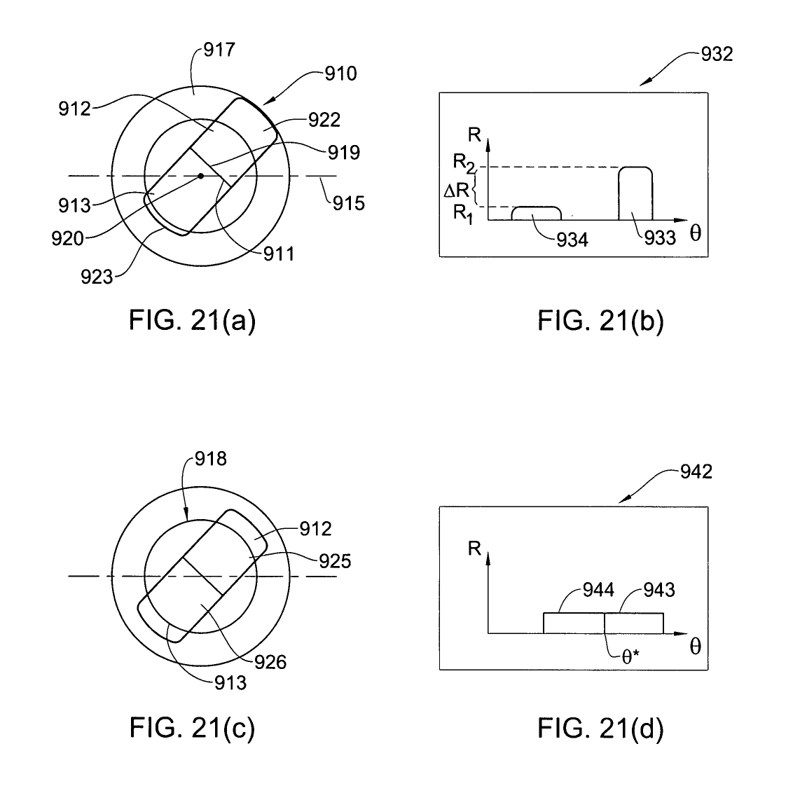

According to another embodiment of the invention, the method above may be further applied to other types of ROI which are associated with instrument displays which do not include a pointer as such. For example, referring to FIGS. 21(a) to 21(d), an ROI image 910 of an attitude detector or the like enables the pitch angle as well as roll angle of the aircraft to be determined. The image 910 comprises an artificial horizon line 911, which is the interface between a “sky” section 912 and a “ground” section 913, which are colored differently one from another. The inclination of the horizon line 911 with respect to a horizontal datum 915 provides the roll angle. Independently, the position of the center 919 of horizon line 911 with respect to the center 920 of the ROI and at 90 degrees to the horizon line 911 provides the pitch angle.

As with embodiments described above, the first step according to the method of the invention is to find the geometric centre of the ROI, and this may be done in substantially the same manner as described above or in any other manner that ensures that ROI image corresponds to a nominally perfect circle. Then, the ROI image 910 is transformed to a R-θ image in a similar manner as described above for the embodiments of FIGS. 14 to 19, mutatis mutandis, but optionally this may be done in two stages.

Referring to FIGS. 21(a) and 21(b), the pitch angle is found in the first stage, as follows. An outer annular portion 917 of the ROI image 910 is transformed to a first R-θ image 932, the radial thickness of the portion 917 being such that an outer part 922 will always be found in this portion, within the range of pitch and roll angles that it is wished to measure. Thus, in the first R-θ image 932 thus produced, there will be one or two lobes 933, 934, corresponding to one or both of these outer parts 922, 923. Then, a value of R corresponding to the maximum radius of each lobe 933, 934, R₂ and R₁ respectively may be determined in any number of ways. For example, starting at a low value of R, a pixel scan is taken along θ, and the lobes identified in a similar manner to that described above for the pointer, mutatis mutandis. Then, at the mid-value or other representative value of θ for each lobe, another pixel scan is taken in the R direction until the edge of the lobe is detected, thereby providing the value of R at that point. The difference between R₂ and R₁, i.e., ΔR, provides a measure of the pitch angle according to a suitable calibration previously performed.

Referring to FIGS. 21(c) and 21(d), in the second stage, the roll angle is determined. An inner portion 918 of the ROI image 910, circumscribed by the annular portion 917, is transformed to a second R-θ image 942. Thus, in the second R-θ image 934 thus produced, there will also be one or two lobes 943, 944, corresponding to one or both of portions 925, 926, respectively, of the “sky” section 912 and of the “ground” section 913 that are within the inner portion 918. Then, the value of θ at the intersection of the two lobes 943, 944, θ*, may be determined in any number of ways, for example by scanning a line of pixels at a particular R value and determining when there is a change in the color thereof corresponding to the horizon line color change. Alternatively, the value of θ at the center of each lobe may be found, which are angularly displaced from the roll angle by 90 degrees.

Where there is a roll and angle as well as a pitch angle, the above methodology regarding FIGS. 21(c) and 21(d) is suitable modified as required.

Alternatively, both the roll angle and pitch angle may be obtained from the ROI of FIGS. 21(a) and 21(b), wherein for example the pitch angle is found as described above, and the roll angle is found by determining the angle of θ for each of the lobes 933, 934, for example in a similar manner to that described in respect of FIGS. 21(c) and 21(d), mutatis mutandis, noting that these angles are angularly displaced from the roll angle by 90 degrees.

Alternatively, both the roll angle and pitch angle may be obtained from the ROI of FIGS. 21(c) and 21(d), wherein for example the roll angle is found as described above, and the pitch angle is found by determining the difference in heights (radius R) of the between the lobes 943, 944, for example in a similar manner to that described in respect of FIGS. 21(a) and 21(b), mutatis mutandis.

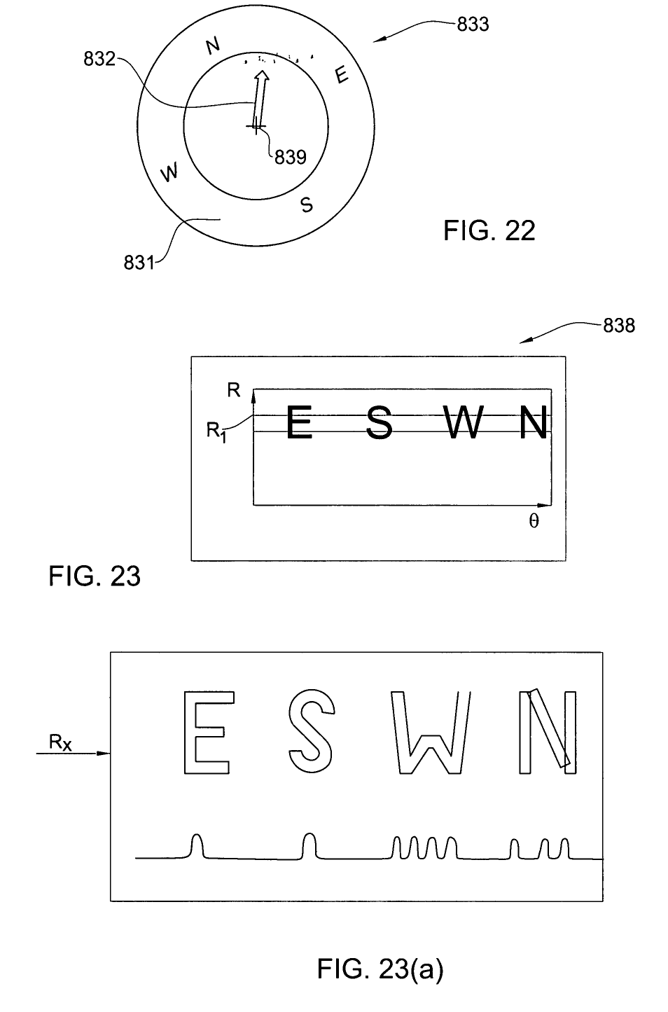

According to yet another embodiment of the invention, the method above may be further applied to other types of ROI which do not include a pointer as such for example corresponding to a horizontal situation indicator (HIS), such as a compass, for example. Referring to FIG. 22, the ROI image 833 of a typical HIS display comprises an outer annular portion 831 comprising the alphanumeric characters “N”, “E”, “S”, “W” arranged circumferentially at 90 degree intervals, representing the four points of the compass. A fixed pointer 832 shows the horizontal orientation or direction of travel of the aircraft, and the annular portion 831 rotates about its center 839 to maintain the “N” character always pointing North, as is known in the art.

As with embodiments described above, the first step according to the method of the invention is to find the geometric centre 839, and this may be done in substantially the same manner as described above or in any other manner that ensures that ROI image corresponds to a nominally perfect circle. Then, and referring to FIG. 23, the annular portion 831 of the ROI image 833 or part thereof is transformed to a R-θ image 838 in a similar manner as described above for the embodiments of FIGS. 14 to 19, mutatis mutandis. In the next processing step, the position of the at least one of the transformed characters “N”, “E”, “S”, “W” in the R-θ image 838 is determined along the θ-axis, and this is also a relatively simple and fast operation. For example, a line of pixels at a particular R value, say R1, on the R-axis may be scanned to determine the distribution in the value of a parameter of the pixels, for example the color, intensity, etc of the pixels, and there will be changes in this value as the line traverses the characters “N”, “E”, “S”, “W”, in a similar manner to that described above for the pointer image 839, mutatis mutandis.

Since the form of the characters “N”, “E”, “S”, “W” in the R-θ image is preknown (except for their location along the θ axis), it is also preknown what the parameter value distribution corresponding to each separate character will be along each particular R value. For example, referring to FIG. 23(a), a pixel scan at a particular value Rₓ reveals a single intensity spike for each of the characters “E” and “S”, four intensity spikes corresponding to the character “W” and three intensity spikes corresponding to character “N”. Accordingly, the scan obtained at a particular R value can be analyzed to identify where the parameter distributions correspond to each one (or at least one) of the characters “N”, “E”, “S”, “W”, and knowing the position of at least one of these characters in terms of angle θ provides the heading with respect to the North direction.

The method may be further enhanced as follows. Where the presence of a character has been located via the pixel scan at a particular R value, a predefined grouping of pixels about this position representing the image of the character (which may not be known at this stage) is taken. Each pixel in this group may be assigned a value of 0 or 1, according to whether it has an intensity corresponding to the background or to the character, respectively. This provides a two dimensional array of 1's and 0's.

Similarly, two dimensional arrays corresponding pixel distributions of images corresponding to each of the characters “N”, “E”, “S”, “W”, can be provided, and each array is multiplied, in turn, by each of four arrays to provide a corresponding number (ten) resulting arrays, and the sum of the 1's in each resulting array is calculated to provide a unique number that represents the resultant array, for example as set out in Table A below:—

TABLE A
Unique Value of Array Obtained when Multiplying
Arrays Corresponding to Character Images

| Character image | Unique value of resultant array |
|---|---|
| E * E | 30 |
| E * S | 15 |
| E * W | 14 |
| E * N | 10 |
| S * S | 28 |
| S * W | 20 |
| S * N | 15 |
| W * W | 26 |
| W * N | 18 |
| N * N | 17 |

Now, the array for the character detected in the scan is multiplied, in turn, by each of aforementioned four arrays corresponding to each of the characters “N”, “E”, “S”, “W”, providing up to four resulting two dimensional arrays, and the sum of the 1's in each resulting array is calculated to provide up to four numbers. If for the case where the scanned character array is multiplied with the array for “E” the resulting number is close to 30, it may be concluded that the scanned character was also an “E”, while if closer to 10, the scanned character corresponds to “N”. Optionally, the same exercise may be applied to the next scanned character, which should also follow the correct sequence as per the instrument.

Referring to FIG. 2, a data reconstruction and display system 200 is provided, particularly for displaying the data received from the data acquisition system 100. According to a first embodiment of the invention, display system 200 comprises a receiver 250 (typically an RF modem) for receiving data transmitted from transmitter 50, a processor such as a computer 230 for analysing the data S received by the receiver 250, and a display 220 for displaying the data.

The system 200 is powered by a suitable power supply 260. The power supply 260 may be a centralized power supply, supplying power to each component of the system, or may comprise individual power units, each powering one or more of the components of the system 200.

The system 200 is adapted for reconstructing the data received thereby to enable another party, such as for example a flight instructor, to view the status of the instrument panel 10, preferably in real time.

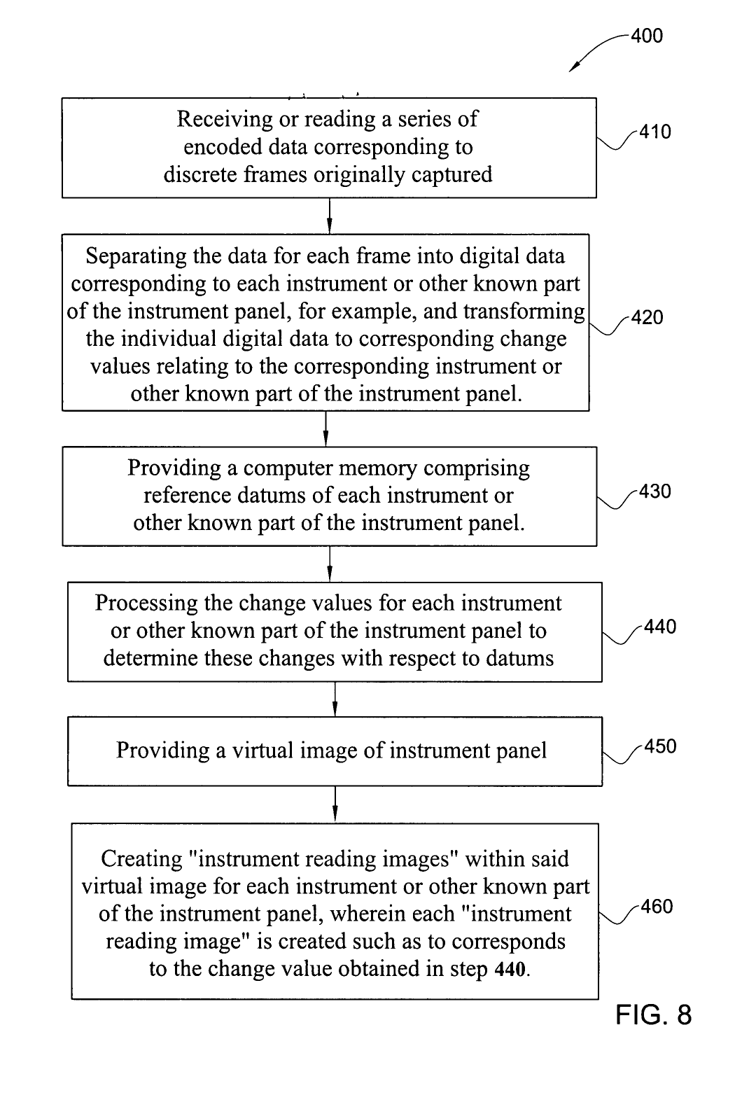

Referring to FIG. 8, the method 400 for displaying data according to one embodiment of the invention, in particular using the system 200, comprises the steps of:—

Step 410: Receiving or reading a series of ASCII data or other encoded data corresponding to discrete frames originally captured.

Step 420: Separating the ASCII data or other encoded data for each frame into digital data corresponding to each instrument or other known part of the instrument panel, for example, and transforming the individual digital data to corresponding change values relating to the corresponding instrument or other known part of the instrument panel.

Step 430: Providing a computer memory comprising reference datums of each instrument or other known part of the instrument panel.

Step 440: Processing the change values for each instrument or other known part of the instrument panel to determine these changes with respect to datums.

Step 450: Providing a virtual image of instrument panel.

Step 460: Creating “instrument reading images” within said virtual image for each instrument or other known part of the instrument panel, wherein each “instrument reading image” is created such as to correspond to the change value obtained in step 440.

Thus, in step 410 the data transmitted by the system 100 is received by system 200. Additionally or alternatively, the system 200 may be adapted to receive the data from memory 240, using any suitable data transfer means, and in this case, the data may be provided as a global data set for example, comprising all the relevant data taken during a particular period of time. Such a memory 240 may be comprised in a crash proof device, which may be recovered from the aircraft after a crash and read by the system 200 to provide instrumentation data, for example, of the aircraft before the crash. According to the invention, the computer 230 may be programmed to receive the data in a particular format. Alternatively, the computer 230 may be programmed to recognize the format in which the data is being sent, and to then analyze the data accordingly. For example, the data may be transmitted as discrete packages of binary data or signals, wherein each packet comprises a string of digital values corresponding to ASCII codes of the readings provided by a number of instruments in a predetermined order.

In such a case, for example, in step 420 the computer 230 analyses a package of digital data at a time, first separating the digital data of the encoded data streams into the ASCII codes (or whatever other method for digitizing the data originally is used) relating to each instrument or other control lever, etc. of the instrument panel, and converts this digital value into a magnitude of a parameter that is being read by the instrument 12. As described above, the order of the ASCII coded digital values in each package may be used to identify the particular instrument that the digital values correspond to. Where instrument 12 is a dial-type instrument, the digital value is converted to an angle in manner that may be the converse of the method by which the original angle of part 112 was originally converted to a digital value by computer 30.

In steps 430 and 440, the magnitude of the parameter is related to a datum value, previously stored in the computer, and typically relating to the position of the marker of the instrument 12, for example, when the reading therein is at zero.

In step 450, the computer 230 displays in display 220 a virtual image of the panel 10, which is typically stored in the memory of the computer. This image may be, for example, a photographic image of the panel, or a graphic or virtual representation thereof. In either case, virtual windows 212 are provided for the actual dials or other markers that indicate the reading of instruments, or switches, digital readouts or displays, and so on, and are left blank at this stage. Indicia representing the scales of each instrument are provided to enable the viewer to read the data from the position of the dial on the display, or the position of a control lever, etc.

In step 460, the computer can then display an image of an indicator in each window 212 in display 220, such that a dial appears at an angle with respect to a known datum corresponding to the received digital value, such as for example a datum that is related to marker 130, when part 112 refers to a dial-type instrumentation.

Alternatively, for windows 212 corresponding to instruments providing a digital readout, the corresponding digital value received by computer 230 is converted to an image of the digits corresponding to this data. Similarly, changes in position of a level, knob, and so on, or different types of display can also be shown in the appropriate window 212 in a manner similar to that originally displayed in panel 10.

Thus, images corresponding to the digital data, corrected from the position of the corresponding datums, are superimposed over an image of this instrument 12, i.e. at the appropriate window 212, and optionally also of the rest of the instrument panel 10, Thus, the display 220 can display a virtual image of the control panel 10, having virtual windows 212 corresponding to each instrument 12. Any changes in the readings of the real instruments 12 are then simulated in the appropriate window 212 of display 220.

Alternatively, rather than displaying the data in graphical format that substantially imitates the original control panel 10, it is possible to display the data in any desired form: for example with respect to a panel having a different layout, but different virtual displays therein still correspond to the instrument displays in the panel 10; alternatively, the data may be displayed in tabular form or in any other form as desired.

Alternatively, computer 230 may process the data F contained in data set S, when the data is received in such a format, as follows. For example, for each digital value P (for a given time frame t1, t2, etc.), the computer 230 identifies the instrument 12 that the string corresponds to, by decoding at least a first part P1 of the digital value P. For this purpose, the decoding computer 230 must be properly programmed with the same codes as the encoding computer 30. Next, the computer 230 reads the remainder of the digital value, P2, as corresponding to a magnitude of a parameter that is being read by the instrument 12. Where instrument 12 is a dial-type instrument, the said remainder P2 is converted to an angle in manner that is the converse of the method by which the original angle of part 112 was originally converted to a digital value P by computer 30. The computer 230 can then display an image of part 112 in display 220 at an angle with respect to a known datum corresponding to the received digital value, such as for example a datum that is related to marker 130. This image is superimposed over an image of this instrument 12 and optionally also of the rest of the instrument panel 10, which was previously stored in the computer 230, and which is related to the marker 130. Thus, the display 220 can display a virtual image of the control panel 10, having virtual windows 212 corresponding to each instrument 12. Any changes in the readings of the real instruments 12 are then simulated in the appropriate window 212 of display 220.

Optionally, the computer 230 can calculate the absolute value of the digital values P, based on a known correlation between the angle and the parameter being measured for the particular instrument 12. The absolute values for the digital values corresponding to each instrument 12 can then be stored or manipulated for each image 110 originally taken of the instrument panel. Since the time interval between successive images is known, (for example, t2-t1, t3-t2, etc.) these absolute values can also be displayed as a function of time.

Preferably, data S is transmitted from system 100 in a continuous manner—as soon as a data string F is created, it is transmitted, and received, processed and displayed by system 200. Since the processing times for the systems 100, 200 and transmission/receiving times for the data S are very small, the system 200 is able to display image data corresponding to the readings of instruments 12 substantially on a real-time basis. One of the advantages of such an integrated data acquisition and display system, comprising system 100 and system 200, when applied to trainer aircraft is that a qualified trainer can view the flight conditions of a trainer aircraft via system 200 while the aircraft is being flown solo by a trainee pilot.

The said integrated system is simple, and thus relatively inexpensive, and is also relatively easy to install, even as a retrofit. It is a separate system to the avionics of the aircraft, and is therefore very versatile. It also has a long range, if ground relays are used. It is thus a useful tool not just for flight training purposes, but also for supervision of flights—with flight safety advantages.

Alternatively, data S can be acquired at any desired acquisition frequency rate, and may transmitted at any desired rate.

Optionally, the data S can be relayed from system 200 to another similar system 200′ remote therefrom, via any suitable communication network, for example to enable third parties to view the data S.

By way of non-limiting example, existing simulators such as the Microsoft Flight Simulator may be adapted in a manner according to the invention to operate as system 200. The Microsoft Flight Simulator comprises a standard interface that enables a user to read and write a set of values to or from the software, the set of values representing parameters such as velocity, altitude etc in appropriate units. In normal usage, the Microsoft Flight Simulator creates data in the gauges of the virtual control panel, typically in response to the flight path defined by user movement of the joystick. According to one aspect of the invention, the readings to the gauges may be input via the said interface, for example as provided via system 100, so that the simulator may be used as a cost effective viewer. Thus, the data S that is transmitted from system 100 may be modified to be compatible with the input format of the Microsoft Flight Simulator, via a transformation process, for example, and input thereto, so that the data is suitably displayed with respect to appropriate gauges in the virtual display.

The integrated data acquisition and display system according to the invention, comprising systems 100 and 200, operatively interconnected via a suitable communications link, may optionally be configured to provide at least one alarm, which may be audio, visual or of any other form, when one or more of the instruments which are being monitored by the system records a reading that is beyond a predetermined threshold. For example, when the instrument reading the aircraft's angle of attack displays a reading that is close to stall for the aircraft, the digitized data corresponding to this reading reaches a predetermined threshold value, and this may trigger an appropriate alarm within system 100, and/or in system 200. Thus, the digitized data corresponding to the instrument readings obtained from the instrument panel image may be analyzed by the computer 30 and/or computer 230, and the data compared to predetermined thresholds as appropriate to trigger alarms once the thresholds are passed.

According to some embodiments of the invention, the system 200 may be adapted to transmit the data S along a land line, or other communication means such as the Internet, a telephone communication system, an intranet, or any other suitable communication medium, to an analogue, second such system 200 which may be located remote from the system 100, and thus enable an instructor to display the data from a location that may be very distant from the system 100. The low bandwidths possible for the data S are especially useful when using an internet connection or the like, wherein the compressed data S may in some cases comprise about 6,600 bits/second, for example, leaving another 3,000 bits/second in a bandwidth of 9,600 bits/second for other uses such as transmission of the pilots audio messages etc.

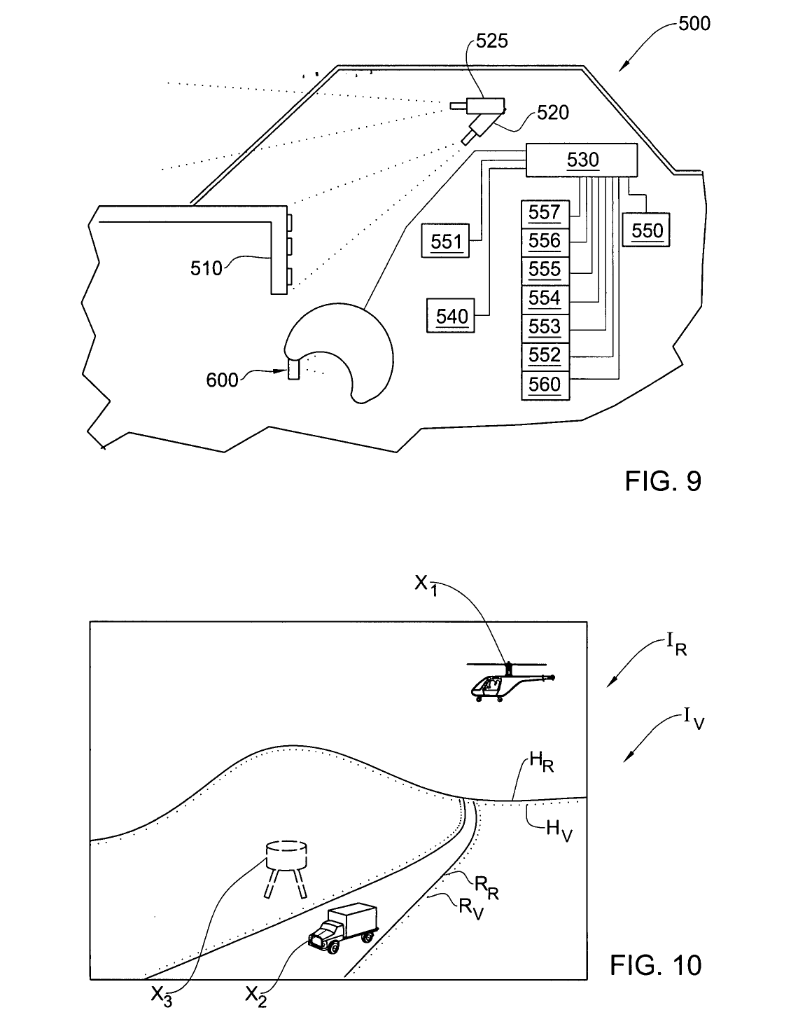

A second embodiment of the data acquisition system of the present invention, generally designated 500, is illustrated in FIG. 9 and comprises all the elements and features of the first embodiment as described above, mutatis mutandis. In the second embodiment, the data acquisition system 500 comprises, at least one camera 520 for capturing images of the instrument panel 510, a computer or other data processing means 530, power supply 560, transmitter 550 and memory 540, similar to the corresponding components of the first embodiment, mutatis mutandis, and these components in the second embodiment interact in a similar manner to those of the first embodiment to provide images of the instrument panel, and based thereon to provide encoded datastreams containing digitized data representative of the data being displayed by the instrument panel.

The system 500 stores the data, and/or transmits data to a suitable data reconstruction and display system, for example the data reconstruction and display system 200 according to the first embodiment, which is now configured to receive, manipulate, analyze and display the type of data transmitted by system 500. As will become clearer herein, this data, in addition to the encoded instrument image data, may also comprise additional digitized data multiplexed therewith.

In addition, the data acquisition system 500 also comprises at least one, and preferably all of the optional features described hereinafter.

Thus, the system 500 may further comprise as a said optional feature a GPS system 551 operatively connected to it, which gives position of the vehicle in which the system 500 is installed, typically an aircraft cockpit, or a DGPS system that also gives the direction in which the vehicle in which the system is installed, is traveling. The data from the DGPS system may be transmitted directly to the data reconstruction and display system 200. Preferably, the digitized data from the GPS or DPGS system is multiplexed with the encoded instrument image data and transmitted (and/or stored) in a similar manner to that described for the encoded instrument image data in the first embodiment, mutatis mutandis.

Alternatively, the image taken with camera 520 may also include the GPS or DGPS readout on the instrument panel itself, and this readout may then be encoded and transmitted in a manner similar to the other instrumentation data.

A further optional feature may include an AHARS module 552, which is typically relatively inexpensive hardware, that provides a digital signal representative of the aircraft attitude, and this data can be transmitted directly to a ground station. Alternatively, and as with the GPS or DPGS digitized data, the attitude digitized data provided by the AHARS module 552 may be multiplexed with encoded instrument image data and transmitted and/or stored, the digitized attitude signal optionally having been compressed. Alternatively, the digitized attitude signal may be routed to the instrument panel and displayed therein, wherein the instrument readout will be enclosed and transmitted with the rest of the data from the instrument panel.

Another optional feature may comprise an audio compression module 553, adapted for receiving audio input from the operator, in this example the pilot's voice and optionally other cockpit sounds, and for digitizing and compressing the audio signal. This compressed audio signal may then be multiplexed with other digitized signals, from example from the AHARS module or GPS/DGPS system, and/or with the encoded instrument image data, and transmitted and/or stored.

Particularly when the system 500 is installed in an aircraft cockpit, another said optional feature of the system 500 may comprise at least one externally-facing camera 525 for taking images corresponding to the pilot's forward field of view outside of the aircraft, such as for example the horizon, which may be defined in an image as a borderline between two image regions, one corresponding to sky (usually above this border, depending on the attitude of the aircraft), and the other corresponding to ground or sea (typically below). The system 100 may be further adapted for identifying the horizon by applying OCR techniques to an image of the horizon taken by the external camera—basically identifying the position and slope of a line in the image that separates one optical domain, such as “sky” from another, such as “ground” or “sea”. The position of the horizon in the image, and where the “sky” is located with respect thereto in the image may be encoded, for example in a similar manner to that described above for some dial-type instruments, mutatis mutandis. This data can be transmitted to the receiving system 200, which then decodes the data and can provide the user of the system 200 an second image (in addition of the image of the instrument panel) showing the horizon as seen by the pilot, for example.

Further, the ground computer 230 may also be programmed to match the position and direction of the vehicle, as given by the GDPS data, and the orientation of the vehicle, as given by the horizon data, with a virtual 3D map of the terrain over which the aircraft is flying, the map having been previously stored in the computer. The computer can be suitably programmed to construct, from this data, an image of what the pilot may be seeing outside the aircraft, including for example mountains, lakes and other topographical features, and also including buildings and so on, according to the resolution of the virtual map. For night flying, the external camera's image may at times pick up light from light sources that may be located atop buildings. The computer 230 may also match the lights with known locations of corresponding building lights in the 3D map, and thus reconstruct a “daylight” image of the scene that matches the night-time scene seen by the pilot.

Alternatively, the on-board computer 530 may be programmed to include a virtual 3D map of the terrain over which the aircraft is flying, and with means for displaying this virtual map from any desired viewpoint and virtual location within the map. Accordingly, the computer 530 may be further adapted for computing from this map the scene as should appear when viewed from the viewpoint of externally facing camera 525, and at a location given by the GPS system 551, with the aircraft attitude as given by the AHARS module 552, and including also aircraft altitude, which may be provided from one of the instruments from the instrument panel via the aforesaid encoded instrument image data. Such a scene is then compared using any suitable electronic or image-based system, or indeed any other suitable hardware or software driven system, with a real image of the scene outside the aircraft as taken by the camera 525. This comparison can be executed at any desired interval, for example at the frequency at which the camera 525 takes individual images. Suitable optical recognition software, for example as marketed under “MATLAB”, may be used for this purpose.

The real image and virtual image should be substantially identical and fit over each other in an exactly superposed manner in all respects except for objects that may sometimes be found in one image, but are missing in the other. The existence of these objects can be registered, and for example their location in the virtual map may be identified and made known to the pilot and/or transmitted to a ground station via system 200 in any suitable manner, including multiplexing with other signals transmitted from the aircraft. For example, referring to FIG. 10, a real image I_{R} (shown as solid lines) is superposed with a corresponding virtual image I_{V} (shown as broken lines), and the respective horizons H_{R} and H_{V}, as well as other terrain features such as respective roads R_{R} and R_{V} substantially coincide. However, there are objects X₁ and X₂ that appear in the real image I_{R} only, corresponding, for example, to a helicopter and ground vehicle, respectively. The existence and location of these objects may be advised to the pilot via any suitable display operatively connected to the computer 530 and/or this data may be transmitted to the ground station, typically multiplexed with other digitized data such as the encoded instrument image data. In fact, having identified the existence of these objects, the actual video image I_{V} may be manipulated such that the image data at the particular location of the object in the image is also transmitted to the ground station as a video signal, so that the video signal may be displayed and particular object may be visually identified. Where these objects are static structures, the image data may optionally be used to update the 3D map, for example.

Furthermore, the location of the objects X₁, X₂ (if these are moving objects) may be tracked with respect to a succession of images taken by the camera 525, and thus the trajectory and velocity of the objects may be determined. Thus, the computer 530 may generate digital data relating to the real-time location, velocity and trajectory of each such object, and this data may be transmitted to a ground station, for example by multiplexing with other transmitted data, and/or recorded in a suitable digital recording device, and/or channeled to a suitable display to be displayed to the pilot.

Similarly, superposition of the real and virtual images may also reveal that an object of the scenery, for example a water tower X₃ is now missing in the real image. This fact may also be alerted to the pilot and/or ground station in a similar manner as described before for objects X₁, X₂, mutatis mutandis, but alerting that the object is missing. The fact that the object is missing may indicate possible damage, for example, or that the features of the terrain have changed since the virtual 3D map was created, and accordingly it may also be possible to isolate the area of each image I_{R} in the vicinity of object, and to transmit these portions of the image as a video data.

The system 500 may further comprise a multiplexing module 554 for multiplexing the digital signals corresponding to the encoded instrument image data and one or all of the following:—GPS or DGPS data; AHARS attitude data; compressed audio voice data; image anomaly data derived from the comparison of images from the externally directed camera 525 and a 3D virtual map. Typically, and by way of a non-limiting example, multiplexing module 554 may comprise a bandwidth of, say, 19,600 or 9,800 bits per second, of which say 3000 bits per second may be assigned to compressed voice data and 16 bits per frame may be assigned for the data corresponding to each instrument of the instrument panel, or about 8 bits per frame for changes in the readings of said instruments relative to a datum or to a previous reading. For example, 16 bits of information such as angles etc, for each of 20 instrument dials, at 15 frames per second, totals 4,800 bits per second.

Further optionally, the system 500 may comprise other data creating modules 555, 556, 557 which are operatively connected to computer 530, for example temperature of the cockpit obtained with an electronic thermometer having a digitized output, physiological data from the pilot obtained via suitable electrodes, for example, a digital video recorder which may be used to record all the data acquired by the computer 530, and so on.

Further optionally, the system 500 may also comprise a helmet display 600 for displaying any suitable data obtained via the system 500 to the pilot. Thus, the computer 530 may be adapted for providing digital data in a suitable form for a standard helmet display 600. For example, the helmet display may display critical instrument readings, obtained from the encoded instrument image data via system 500, and/or positional or other data corresponding to anomalous objects in the field of view of the externally facing camera 525.

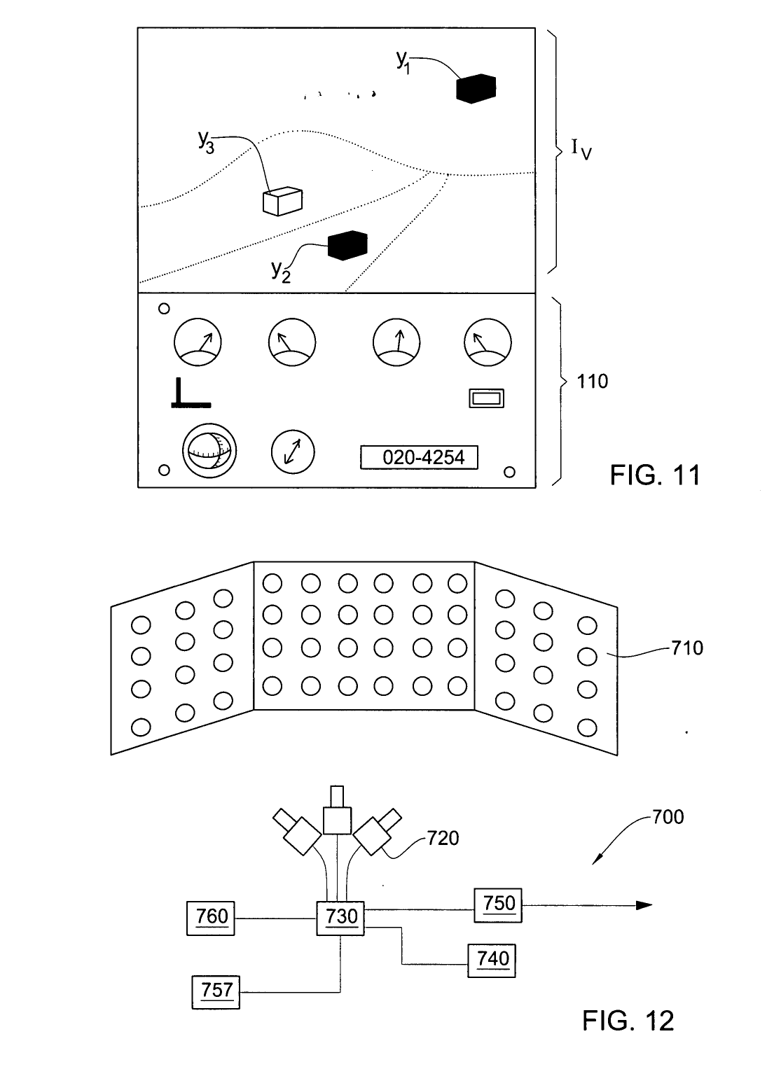

Accordingly, the data receiving and display system 200 is also adapted to receive, manipulate, analyze and display the type of data transmitted by system 500, which, in addition to the encoded instrument image data, may also comprise additional digitized data multiplexed therewith including one or more of the following:—GPS or DGPS data; AHARS attitude data; compressed audio voice data; image anomaly data derived from the comparison of images from the externally directed camera 525 and a 3D virtual map. Of course, the systems 500 and 200 are synchronized so that the multiplexed data stream transmitted by the system 500 is properly read by the system 200. Thus, when used with the system 500 according to the second embodiment, the system 200 is able to display a virtual image of instrument panel, with real-time readings of the instrument displayed therein as in the first embodiment, mutatis mutandis. In addition, when used with the system 500 of the second embodiment, the system 200 may also display GPS or DGPS data and attitude data in any convenient manner—for example via additional “virtual instruments” in the virtual instrument panel displayed thereby, or in any other suitable manner, for example a dedicated display, printout, graph and so on. In addition, the system 200 can also decompress and broadcast audio voice data received from the pilot so that the ground station can hear the pilot in substantially real-time without having to use the main radio of the aircraft. Furthermore, the system 200 is adapted for receiving and analyzing the aforesaid image, anomaly data, and may comprise an additional display (virtual and/or real display) for displaying in real time the 3D virtual map of the terrain over which the aircraft is flying, as viewed from the vantage point of the camera 525, and thus takes into account attitude data, GPS or DGPS data, and altitude data received thereby. As illustrated in FIG. 11, for example, the system 200 may display a composite image including image I_{V} corresponding to the virtual 3D map as seen from the vantage point of the pilot, together with a virtual image of the instrument panel 110 having the real-time readings of the instruments displayed thereon according to the invention. The image I_{V} includes markers Y₁, Y₃ and Y₃, corresponding to the anomalous objects X₁, X₃ and X₃, as determined by system 500.

In particular, the system 200 may annotate the virtual map display at the locations in which a visual anomaly was found, and mark the spot as comprising an unknown object, together with a velocity vector and trajectory if appropriate. Furthermore, where appropriate, the system 200 may also superimpose on the virtual map image of the scene actual image data received from the camera 525 relating to the same part of the image to identify the nature of the object. Alternatively, the digitize data of the part of the real image corresponding to the location of the anomalous object may be displayed on its own via a dedicated real or virtual display and enhanced or magnified as desired using appropriate software, for example.

The above system and method for detecting and alerting/displaying an anomalous object in the field of view of the pilot may also be used in many other applications, for example a train. A forward facing camera on a train, together with a GPS system, may provide data to an on-board computer that has a virtual 3D man of the route, and anomalies found when comparing the video images with corresponding virtual images, particularly regarding obstruction to the tracks, or even possible damage of the tracks may be identified and brought to the attention of the driver in a similar manner to that described above, mutatis mutandis.

Optionally, the system 200 may comprise a plurality of displays for monitoring data corresponding to a plurality of different aircraft. In other, non-aircraft applications, the system 200 may comprise a plurality of displays for monitoring data corresponding to a plurality of different data transmitters, such as for example different trains, power stations and so on.

In each embodiment, the encoded instrument image data and digitized data from the AHARS, GPS, audio compression module, and so on may be recorded in any suitable digital recording system.

According to another aspect of the invention, one or more additional cameras may be installed in the cockpit, but directed to imaging the pilot's face and/or the faces of the flight crew where appropriate. Suitable face-recognition software such as used in security systems currently used at the entrance to restricted areas may be provided to analyze the face image(s) and to compare them with photos of the pilot/crew. If the images do not match, or if the system is tampered with, a signal may be sent to the ground station alerting that there may a hostile or unauthorized takeover of the aircraft.

While the integrated data acquisition and display system of the present invention has been described in part with respect to an aircraft cockpit or flight cabin, there are many other applications possible with the invention. For example, the integrated data acquisition and display system may be used for recording data at a power station where control panels use hundreds of dials for monitoring conditions therein. For example, referring to FIG. 12, a third embodiment of the data acquisition system of the present invention, generally designated 700, comprises all the elements and features of the first or second embodiments as described above, mutatis mutandis. In the third embodiment, the data acquisition system 700 comprises, a cluster of cameras 720 for capturing images of the analogue and/or digital instrument panel 710, a computer or other data processing means 730, power supply 760, transmitter 750, digital video recorder 757 and memory 740, similar to the corresponding components of the first or second embodiments, mutatis mutandis, and these components in the third embodiment interact in a similar manner to those of the first or second embodiments to provide images of the instrument panel, and based thereon to provide encoded datastreams containing digitized data representative of the data being displayed by the instrument panel. This data, which may be further suitably multiplexed, may be transmitted to a central monitoring facility via a transmitter 750, for example an RF transmitter, or via any other data communication link, for example, a satellite link, telephone lines, internet connection, and so on. The central monitoring facility comprises a suitable data reconstruction and display system, for example the data reconstruction and display system 200 according to the first or second embodiments, which is now configured to receive, manipulate, analyze and display the type of data transmitted by system 700.

The integrated data acquisition and display system may optionally be configured to provide an alarm, which may be audio, visual or of any other form, when one or more of the instruments which are being monitored by the system records a reading that is beyond a predetermined threshold, for example when the temperature of a coolant exceeds a safe temperature.

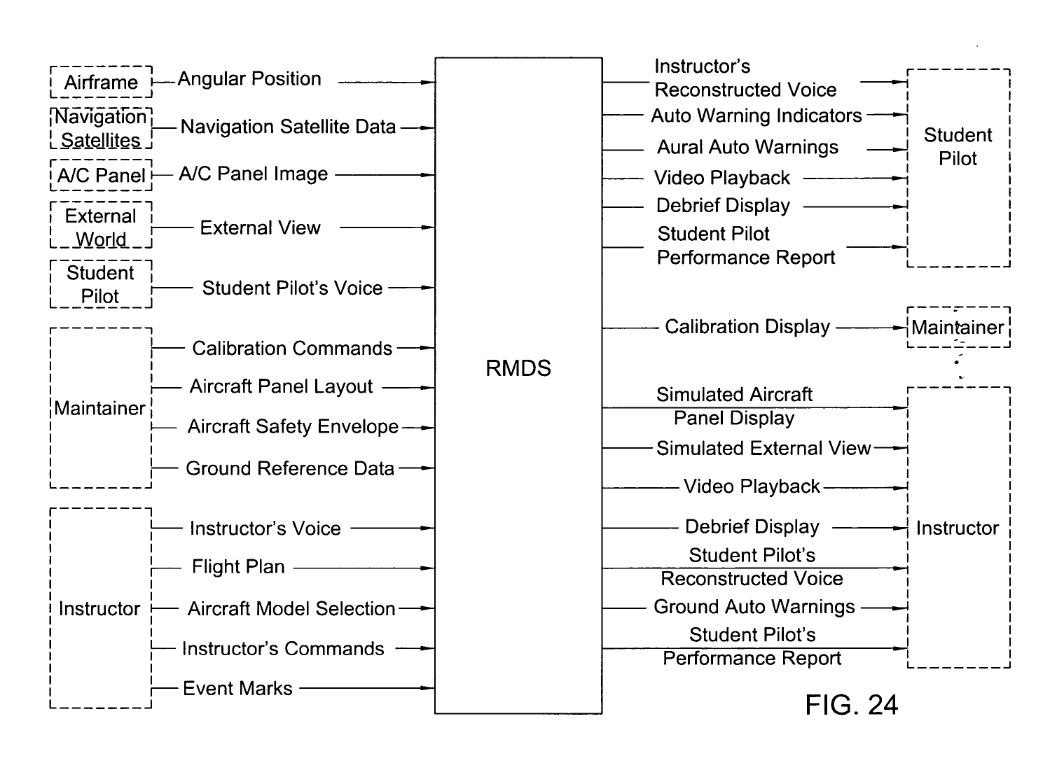

Another embodiment of a data acquisition and display system according to the invention is illustrated in FIG. 24. The system, designated “RMDS” in this figure, is particularly adapted for use with an aircraft for the purpose of student training, in particular to provide real-time flight information to an instructor in a ground station, and optionally for assisting the pilot in flight preparation and/or in debriefing the pilot after flight. A number of inputs are provided (annotated with respect to a plurality of input arrows from sources on the left side of the figure, as follows:—

The source “airframe” refers to the aircraft airframe, and is associated with an Angular Position input, which refers to the physical orientation of the aircraft in three-dimensional space.

The source “navigation satellites” refers to a constellation of navigation satellites, e.g., NAVSTAR GPS, Galileo, and provides navigation satellite data input, including transmissions from the navigation satellites that allow the aircraft location to be computed.

The source “A/C panel” refers to an aircraft instrument panel, and provides an A/C Panel Image, i.e., one or more images of the aircraft instrument panel.

The source “external world” refers to the world outside the aircraft and provides an external view input, which may be one or more images of the scenery seen from the cockpit.

The source “student pilot” refers to the person piloting the aircraft, and provides student pilot's voice input, which is the voice of the pilot student, as detected in the cockpit.

The source “maintainer” refers to a maintenance person, for example, responsible for the preparation of the RMDS system for a training sortie, and provides various inputs as follows: Calibration Commands. which may include commands and data entered by the maintainer in the course of system calibration; Aircraft Panel Layout, which may include a graphical definition of the layout of the aircraft instrument panel that will be used to reproduce the aircraft panel on the instructor's display. Multiple panel layouts of various aircraft models may be stored in the system's library; Aircraft Safety Envelope, which may include definition of spatial and dynamic limits that must not be exceeded during the flight for safety reasons; Ground Reference Data, which may include a digital terrain model (DTM) of the area above which the flight takes place, and geo-located imagery needed to generate simulated landscape.

The source “instructor” refers to the person monitoring the training mission from the ground, and provides the following inputs: Instructor's Voice, i.e., the voice of the instructor, as received in the instructor's station; Flight Plan, which may include time-tagged 3-D/2-D specification of the flight route to be followed by the student pilot; Aircraft Model Selection, which may include a selection of data corresponding to the type of aircraft to be used for training on a given training mission; Instructor's Commands, which may include commands that control the operation of the Ground Segment; Event Marks, which may include tags attached to recordings made onboard the aircraft and in the Instructor's station that facilitate easier access during playback and debriefing.

A number of outputs are provided by the RMDS, annotated with respect to a plurality of input arrows to the blocks marked “student pilot”, maintainer” and “instructor” on the right side of the figure, as follows:—

The Student Pilot receives the following outputs from the RMDS: Instructor's Reconstructed Voice, i.e., the voice of the Instructor, reconstructed in the cockpit; Aural Auto Warnings, including aural warnings generated in the cockpit when Auto Warning Indicators are set; Auto Warning Indicators, including automatic warnings generated in the cockpit when the actual flight path significantly deviates from the flight plan, when Aircraft Safety Envelope is exceeded, or when Ground Auto Warning is received; Video Playback, including a playback of video recorded during a training mission; Debrief Display, including reconstruction of the display produced on the instructor's display during the training mission; Student Pilot's Performance Report, including a report summarizing and grading the Student Pilot's performance during the training mission.

The Maintainer receives a calibration display output from the RMDS, including a display produced during the calibration process.

The Instructor receives the following outputs from the RMDS: Simulated Aircraft Panel Display, including a synthetic image of the current state of the aircraft instrument panel, including current values of gauges and digital displays, and state of switches, levers and indicators; Simulated External View, including a synthetic image of the ground as would be seen from the cockpit; Video Playback, including a playback of video recorded during a training mission; Debrief Display, including reconstruction of the display produced on the instructor's display during the training mission; Student Pilot's Reconstructed Voice, i.e., the voice of the Student Pilot, reconstructed at the Instructor's station; Ground Auto Warnings, including automatic warnings generated by the instructor's station when the actual flight path significantly deviates from the flight plan, when Aircraft Safety Envelope is exceeded, or when the instructor decides to activate a warning (the warnings are transmitted to the aircraft); Student Pilot's Performance Report, including a report summarizing and grading the Student Pilot's performance during the training mission.

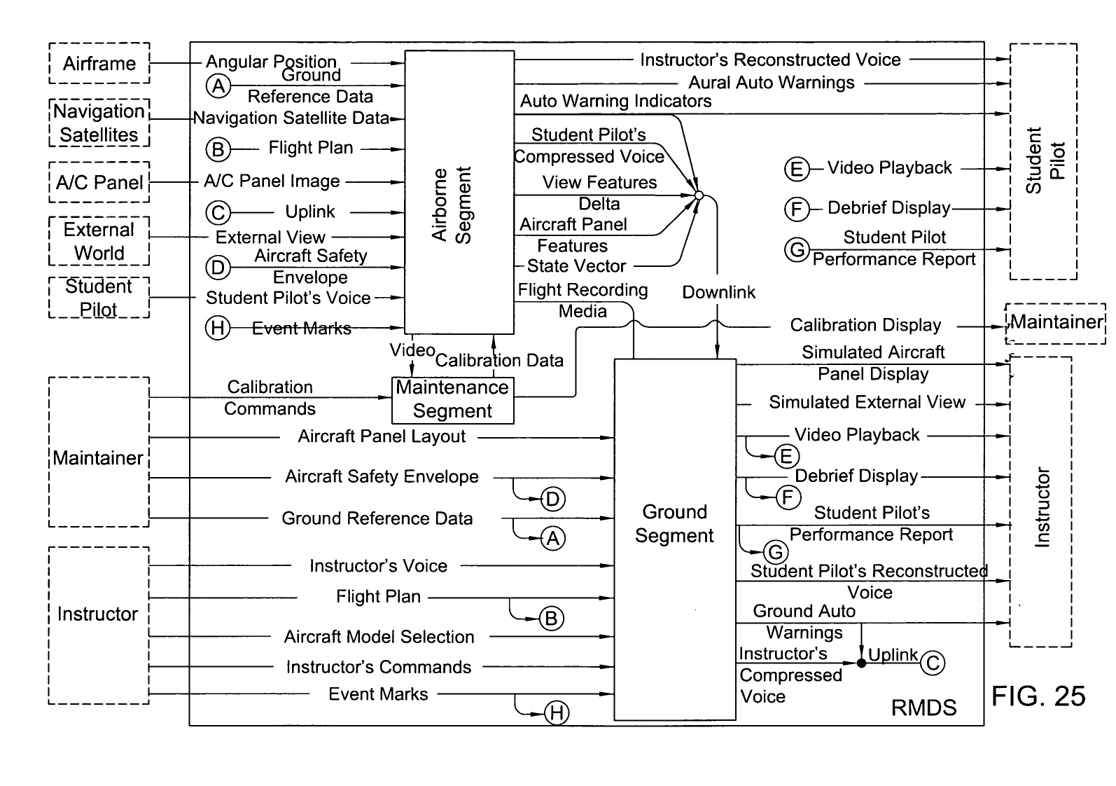

Referring now to FIG. 25, the RMDS comprises a number of modules referred to as:
An Airborne Segment, which is a subsystem installed on the aircraft;
A Ground Segment, which refers to the Instructor's station used to monitor the flight and provide guidance to the student pilot, to carry out post-mission debrief, to assess the student pilot's performance and to manage student's records; and
a Maintenance Segment, which is a subsystem used to calibrate the cameras installed on the aircraft.

The Airborne Segment module has a plurality of inputs from the aforesaid sources and from the Maintenance Segment module, and outputs to the Maintenance Segment module, Student Pilot, and Ground Segment module, and the inputs and outputs are indicated on input/output arrows with respect to the Airborne Segment module in FIG. 25. A number of these inputs and outputs have already been described in respect of FIG. 24, and the remainder is described below:
Uplink, which includes information transmitted from the ground station to the aircraft. This information includes compressed voice of the instructor, and automatic warnings generated by the ground station;
Video, which includes real-time imagery acquired by cockpit cameras;
Calibration Data, which includes a set of parameters that allows to precisely extract the Gauges Angles from the imagery of the aircraft panel, and to decode the state of switches, levers and indicators on the panel as well as the values of digital displays;
Student Pilot's Compressed Voice, which includes the Student Pilot's voice, following digitalization and compression;
View Features Delta, which refers to geographically-located features that appear in real-time imagery but not in the reference imagery or vice versa;
Aircraft Panel Features, which includes data describing the position of gauges, switches and levers on the aircraft instrument panel, and values presented on digital displays;
State Vector, which includes a vector that specifies the location and orientation of the aircraft at a given time;
Flight Recording Media, which includes media containing video, audio and digital data recorded during the flight;
Downlink, which includes information transmitted from the aircraft to the ground (this information may include Compressed Student Pilot's Voice, View Features Delta, Aircraft Panel Features, and the current State Vector).

The Maintenance Segment module has inputs from the Maintainer source and from the Airborne Segment module, and provides an output to the Maintainer, as shown in FIG. 25.

The Ground Segment module has a plurality of inputs from the aforesaid sources and from the Airborne Segment module, and outputs to the Student Pilot and Instructor, and to the Airborne Segment module, and the inputs and outputs are indicated on input/output arrows with respect to the Ground Segment module in FIG. 25. A number of these inputs and outputs have already been described in above, and output marked as “Instructor's Compressed Voice” refers to the Instructor's voice, following digitalization and compression.

It is to be noted that the capital alphanumeric characters A, B, C, D, E, F, G, H are provided in this figure to aid in clarification of the figure, and serve to link together various inputs/outputs to other input/outputs. For example, character C links the Uplink output of the Ground Segment Module to the Uplink input to the Airborne Segment module.

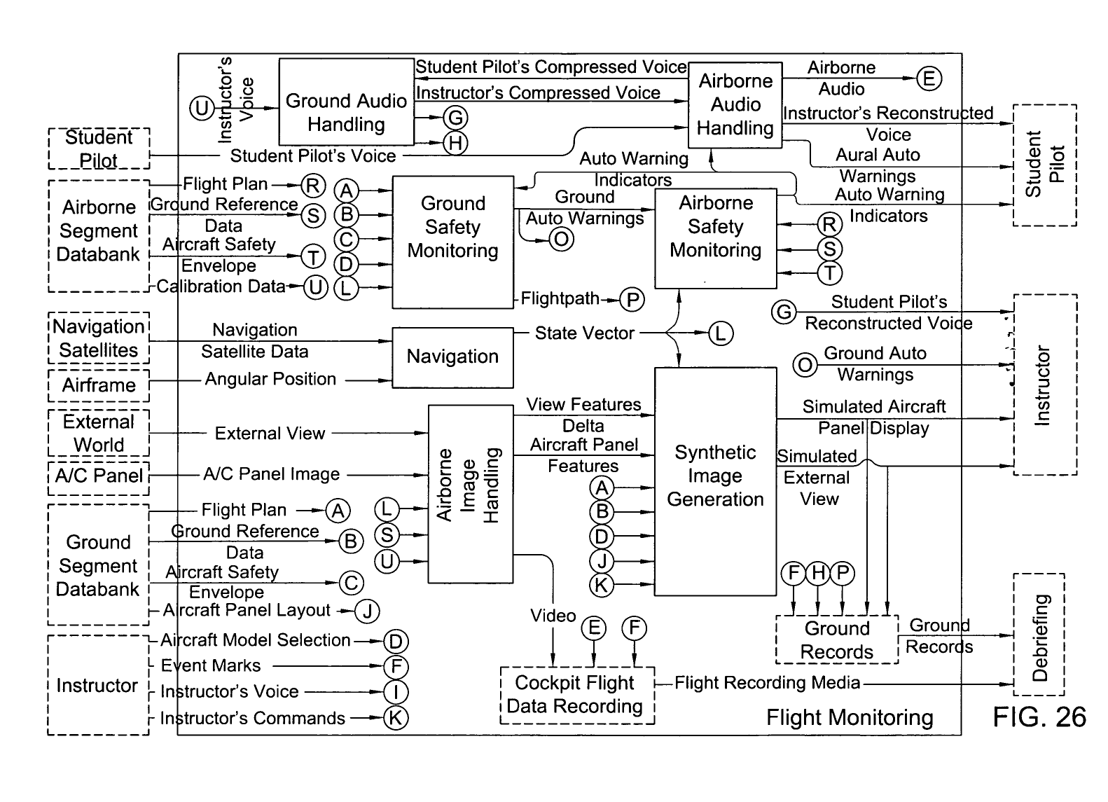

FIG. 26 illustrates some data flow paths and data handling with respect to the RMDS, its input sources and output destinations of FIG. 24, and also with respect to some data banks and operating modes. Some of these elements have already been described above with respect to FIGS. 24 and 25. Additional elements, including functions, and data flows, data stores and operating modes not previously described are now described in Table I below:

TABLE I
Element Name, Element Type and Description
of some elements shown in FIG. 26

| Element | Element | |
|---|---|---|
| Name | Type | Description |
| Ground Audio | Function | Digitization and compression of the |
| Handling | | Instructor's Voice, and decompression |
| | | and reconstruction of the Student |
| | | Pilot's Compressed Voice |
| Airborne Audio | Function | Digitization and compression of the |
| Handling | | Student Pilot's Voice, and |
| | | decompression and reconstruction of |
| | | the Instructor's Compressed Voice. |
| | | This function also generates Aural |
| | | Auto Warnings when Auto Warnings |
| | | Indicators are set |
| Airborne Image | Function | Acquisition of imagery captured by |
| Handling | | cameras installed in the aircraft, |
| | | its digitization, extraction and |
| | | encoding of features from images of |
| | | the instrumentation panel, and |
| | | extraction of features of the |
| | | External View that differ from the |
| | | Ground Reference Data |
| Airborne Safety | Function | Monitoring of the aircraft state in |
| Monitoring | | order to set Auto Warning Indicators |
| | | in any of the following conditions: |
| | | when the actual flight path deviates |
| | | significantly from the flight plan, |
| | | when the aircraft enters forbidden |
| | | airspace, when the actual aircraft |
| | | speed, orientation and altitude may |
| | | lead to loss of control, and in case |
| | | of imminent controlled flight into |
| | | terrain (CFIT). The Auto Warning |
| | | Indicators are also set upon reception |
| | | of Ground Auto Warnings from the |
| | | Ground Segment |
| Ground Safety | Function | Monitoring of the aircraft state in |
| Monitoring | | order to set Ground Auto Warnings in |
| | | any of the following conditions: |
| | | when the actual flight path deviates |
| | | significantly from the flight plan, |
| | | when the aircraft enters forbidden |
| | | airspace, when the actual aircraft |
| | | speed, orientation and altitude may |
| | | lead to loss of control, and in case |
| | | of imminent controlled flight into |
| | | terrain (CFIT) |
| Navigation | Function | Computation of the aircraft location, |
| | | speed and orientation |
| Cockpit Flight | Data Store | Recording of the video and aural |
| Data Recording | | sensors installed in the cockpit |
| | | made for documentation and debriefing |
| | | purposes |
| Ground Records | Flow | Data recorded by the instructor's |
| | | station during a flight. It includes |
| | | the Simulated Aircraft Panel Display, |
| | | the Simulated External View, the |
| | | Ground Audio, the actual Flightpath, |
| | | and Student Data |
| Debriefing | Operating | Operating mode in which the debriefing |
| | Mode | (see Debriefing function) is carried out |
| Debriefing | Function | A structured conversation with a |
| | | Student Pilot following a training |
| | | mission, focusing on analysis of |
| | | his or her performance and correction |
| | | of mistakes made during the training |
| | | mission |
| Airborne | Data Store | Nonvolatile storage onboard the |
| Segment | | aircraft, which stores data and |
| Databank | | parameters needed to operate the |
| | | Airborne Segment |
| Ground | Data Store | Nonvolatile storage in the |
| Segment | | Instructor's Station, which |
| Databank | | stores data and parameters needed |
| | | to operate the Ground Segment |
| Airborne Audio | Flow | Instructor's Voice received in the |
| | | aircraft and the Pilot Student's |
| | | Voice |
| Synthetic Image | Function | Generation of synthetic images of |
| Generation | | the aircraft instrumentation panel |
| | | and of the scenery outside the |
| | | aircraft |

It is to be noted that the capital alphanumeric characters A through to U are provided in FIG. 26 to aid in clarification of the figure, and serve to link together various elements to other elements. For example, character S links the ground reference data provided by the Airborne Segment Databank to the Airborne Safety Monitoring function.

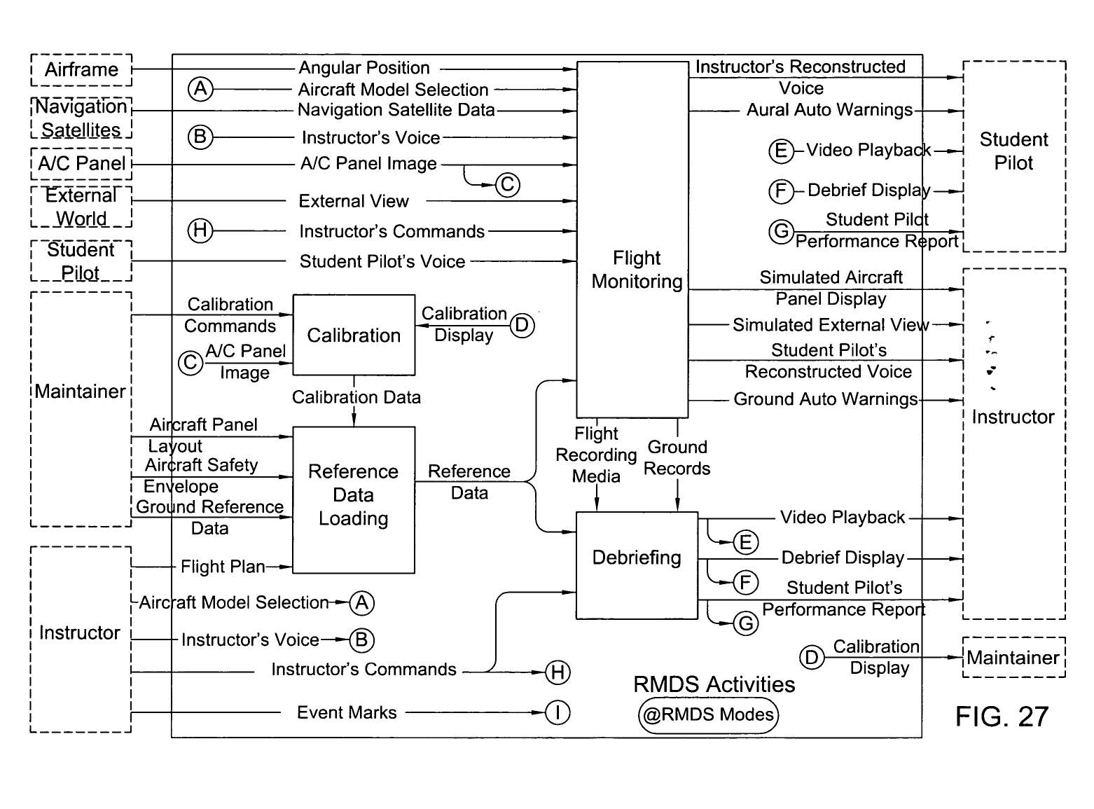

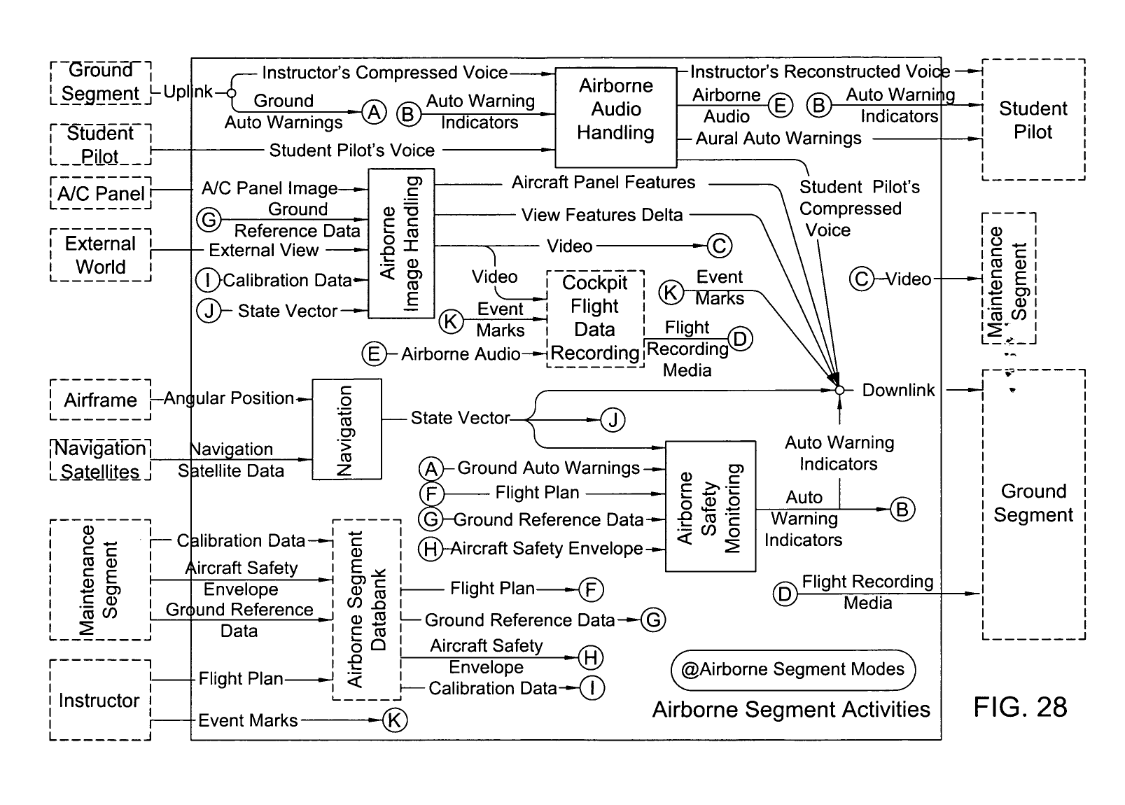

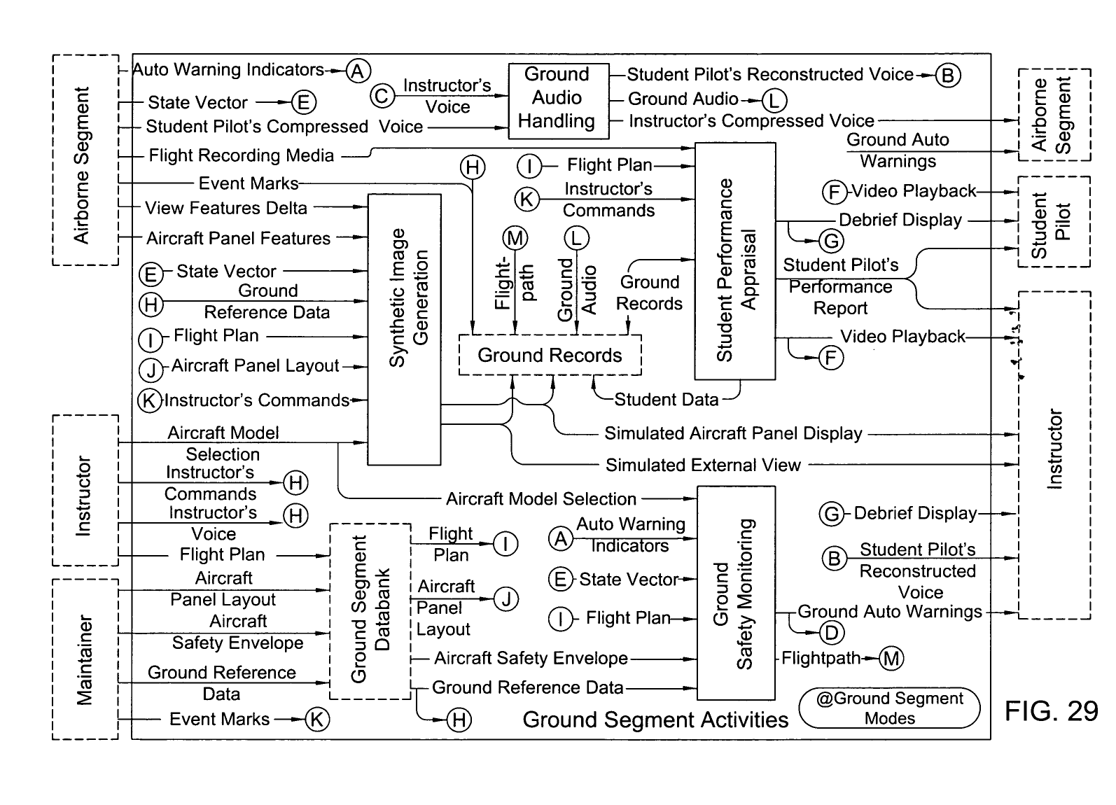

FIGS. 27, 28, 29 illustrate functionalities relating to RMDS activities, Airborne Segment activities and Ground Segment activities, respectively. Some of the elements shown in these figures have already been described above with respect to FIGS. 24 to 26. Additional elements, including functions, operating mode, conditions, events, and data flows, not previously described, are now described, inter alia, in Table II below:

TABLE II
Element Name, Element Type and Description
of some Elements shown in FIGS. 27, 28, 29

| Element | Element | |
|---|---|---|
| Name | Type | Description |
| Calibration | Function | Adapting and adjusting the subsystem |
| | | that performs image acquisition and |
| | | processing onboard the aircraft to |
| | | properly identify the gauges, switches, |
| | | levers and indicator on the aircraft |
| | | panel and to “read” their values |
| Calibration | Operating | The subsystem that performs image |
| | Mode | acquisition and processing is |
| | | undergoing calibration (see |
| | | Calibration function) |
| Calibration | Condition | The calibration (see Calibration |
| Completed | | function) is completed |
| Calibration | Event | Calibration of the subsystem that |
| Requested | | performs image acquisition and |
| | | processing onboard the aircraft was |
| | | requested |
| Debriefing | Condition | Debriefing was completed |
| Completed | | |
| Debriefing | Event | Post-mission Debriefing was |
| Requested | | requested |
| Debriefing | Condition | Post-mission Debriefing mode was |
| Selected | | selected |
| Flight | Function | Monitoring of a flight by an |
| Monitoring | | instructor |
| Ground | Flow | Instructor's Voice and the Pilot |
| Audio | | Student's Voice received from the |
| | | aircraft |
| Leave | Event | An event signifying that the system |
| | | is not going to be used for some |
| | | period of time |
| Mode Select | Operating | In this operating mode a selection |
| | Mode | is made how to use the RMDS system |
| | | (preparations for a training mission/ |
| | | training mission/post-mission debriefing) |
| Off (in | Operating | In this operating mode the Airborne |
| Airborne | Mode | Segment is not in use |
| Segment Modes) | | |
| Off (in Ground | Operating | In this operating mode the Ground |
| Segment Modes) | Mode | Segment is not in use |
| Off (in RMDS | Operating | In this operating mode the RMDS |
| Modes) | Mode | system is not in use |
| Operation | Operating | The Airborne Segment is in operation |
| | Mode | |
| Operation | Condition | Operation of the Airborne Segment |
| Completed | | was completed |
| (in Airborne | | |
| Segment Modes) | | |
| Operation | Condition | Operation of the Ground Segment |
| Completed | | was completed |
| (in Ground | | |
| Segment Modes) | | |
| Operation | Event | The Airborne Segment is to enter |
| Requested | | operation |
| (in Airborne | | |
| Segment Modes) | | |
| Operation | Event | The Ground Segment is to enter |
| Requested | | operation |
| (in Ground | | |
| Segment Modes) | | |
| Post-mission | Operation | In this operating mode the instructor's |
| Debriefing | Mode | station is used to reenact the training |
| | | mission with the student pilot using |
| | | material recorded onboard the aircraft |
| | | and in the instructor's station |
| Preparations | Operating | In this mode the aircraft and/or the |
| | Mode | instructor's station are prepared for |
| | | operation. While in this mode, the |
| | | system installed onboard the aircraft |
| | | may be calibrated (see Calibration |
| | | function) and/or data necessary to |
| | | perform a training mission may be |
| | | loaded into the airborne segment/ |
| | | the ground segment |
| Preparations | Condition | All preparations for a training mission |
| Completed | | were completed |
| Preparations | Condition | Preparations mode was selected |
| Selected | | |
| Reference | Flow | Reference data needed to carry out a |
| Data | | training mission and perform a post- |
| | | mission debriefing. It includes |
| | | Calibration Data, Aircraft Panel Layout, |
| | | Aircraft Safety Envelope, Ground |
| | | Reference Data, and the Flight Plan |
| Reference | Function | Loading into the system of data |
| Data Loading | | necessary to perform a training |
| | | mission over a specific area |
| | | using a specific aircraft |
| Selection | Event | A service to be performed by the |
| Made | | system was selected. Available |
| | | services are: Calibration and |
| | | Reference Data Loading (in |
| | | Preparations mode), Flight (in |
| | | Training mode) and Debriefing |
| | | (in Post-mission Debriefing mode) |
| Student | Flow | Data pertaining to the Student Pilot |
| Data | | and his performance |
| Student | Function | Appraisal of the training mission |
| Performance | | flown by the Student Pilot, carried |
| Appraisal | | out within the framework of debriefing |
| Training | Operating | In this mode the airborne segment |
| | Mode | and the ground segment are cooperating |
| | | in monitoring the training mission |
| Training | Condition | A training mission was completed |
| Completed | | |
| Training | Condition | Training mode was selected |
| Selected | | |
| Use System | Event | An event signifying that the system |
| | | is going to be used |

It is to be noted that the capital alphanumeric characters A, B, C etc. are provided in FIGS. 27, 28 and 29 to aid in clarification with respect to the particular figure in which they appear, and serve to link together various elements to other elements within the same figure.

The present invention also relates to a computer readable medium storing instructions for programming a processor means of the data acquisition system of the invention to perform a data acquisition method of the invention.

The present invention also relates to a computer readable medium storing instructions for programming a processor means of a data display system of the invention to perform the data display method of the invention.

Such computer readable media may include, for example, optical discs, magnetic discs, magnetic tapes, RAM memory, and so on.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed exemplary embodiments in accordance with the invention, it will be appreciated that many changes may be made therein without departing from the spirit of the invention.

1. A method for acquiring data from an instrument panel having at least one instrument display wherein a value of a parameter being monitored via the display is associated with at least an angular disposition of an indicator with respect to the display comprising:—
(a) providing a first image of said at least one angular display comprising a plurality of image elements;
(b) transforming at least a portion of said first image into a corresponding R-θ image, wherein each said image element of the at least portion of said first image is relocated in said R-θ image to a position with respect to a first axis and a second axis according to the radius (R) and angular disposition (θ), respectively, of said image element with respect to a center and datum angle, respectively, in said first image;
(c) identifying said parameter value from said R-θ image by identifying an image corresponding to at least a part of said indicator therein and determining a position of said indicator with respect to said R-θ image;
(d) providing a coded data stream representative of said parameter value;
(e) at least one of transmitting and recording said coded data stream.

2. A method according to claim 1, wherein step (a) comprises providing a global image of said panel having a plurality of said displays, and further comprising dividing the said global image into a corresponding plurality of said first images, each corresponding to a region of interest (ROI), wherein each said ROI comprising one said display, and wherein steps (b) to (e) may be performed for each said ROI.

3. A method according to claim 2, wherein at least one said ROI comprises said indicator in the form of an image of a dial that points to the said parameter value, and step (c) comprises identifying a position of said dial in said R-θ image with respect to said second axis.

4. A method according to claim 3, wherein said coded data stream comprises digital values representative of said angular disposition.

5. A method according to claim 3, further comprising serially compiling said coded data stream for each said ROI into a data package.

6. A method according to claim 1, further comprising a calibrating procedure for determining a position of said center in said first image prior to step (a).

7. A method according to claim 6, wherein said calibrating procedure includes the sub steps:—
(i) providing a first calibration image of said at least one angular display;
(ii) analyzing said first calibration image to identify a center of rotation with respect to an angular rotation of said indicator.

8. A method according to claim 7, wherein sub step (ii) comprises:—
(ii-a) analyzing said first calibration image to identify a periphery of the display that is nominally circular about said center;
(ii-b) if said periphery is circular within a predefined tolerance determining and providing the location of said center;
(ii-c) if said periphery is not circular: (A) determining a calibration transformation required for elements of the said first calibration image such that said periphery in said calibration image is transformed to a circular shape in a second calibration image created via said calibration transformation; and (B) determining a location of a transformed center of the circular shape in the second calibration image.

9. A method according to claim 8, wherein said second calibration image is used as said first image in step (a).

10. A method according to claim 1, wherein steps (a) to (d) are applied to a plurality of said instrument displays of instruments that monitor at least engine conditions of at least one engine, and further comprising the step of analyzing said data stream with respect to reference data to obtain a measure of engine performance.

11. A method according to claim 10, wherein said analyzing step comprises comparing actual engine data as provided via said data stream with reference engine data obtained at substantially the same operating conditions to provide a deviation therebetween, and generating an alert when said deviation exceeds a predetermined threshold.

12. A method according to claim 1, further comprising the step of recording said coded data streams in a crash proof device.

13. A method according to claim 1, wherein step (c) comprises transmitting said coded data streams by means of a radio signal.

14. A method according to claim 1, wherein said parameter includes at least any one of airspeed, altitude, pitch, roll, yaw, turn rate, vertical speed, horizontal situation (compass heading), engine rpm, oil status, fuel status, oil temperature, Mach number, chronological time.

15. A method according to claim 1, further comprising the step of providing at least one second image of an external environment.

16. A method according to claim 15, further comprising the step of providing at least one of: attitude data, GPS data, DGPS data, altitude data, voice data.

17. A method according to claim 16, further comprising the steps:—
(A) providing a virtual image corresponding to the said external environment corresponding to said at least one said second image;
(B) comparing said at least one second image with said corresponding virtual image;
(C) identifying differences between the images in step (B).

18. A method according to claim 17, further comprising providing digital data representative of said differences in step (C) and optionally displaying said digital data.

19. A method according to claim 18, further comprising including at least one of said attitude data, GPS data, DGPS data, altitude data, voice data, said digital data representative of said differences in step (C), in said coded data stream.

20. A method according to claim 1, wherein said image element comprises at least one pixel.

21. A method according to claim 1, further comprising providing an image of a user that is facing said panel, analyzing said image and comparing with images of authorized users, and further comprising the step of generating an alert if the said user image does not match at least one authorized user image.

22. A method for displaying data comprising:—
(i) at least one of receiving and reading a coded data stream representative of an image of said at least one display of an instrument panel;
(ii) creating an image of said at least one readout based on said corresponding said coded data stream;
(iii) displaying said image in the context of an image representative of said panel.

23. A method according to claim 22, wherein said coded data stream is created by imaging said at least one instrument panel display to provide a first image thereof, and manipulating said first image to provide said coded data stream, wherein said coded data stream is representative of at least one value of a parameter being monitored at the display.

24. A method according to claim 22, wherein said coded data stream is created according to a method for acquiring data from an instrument panel having at least one instrument angular display wherein a value of a parameter being monitored at the display is associated with at least an angular disposition with respect to the display comprising:—
(a) providing a first image of said at least one angular display
(b) transforming at least a portion of said first image into a corresponding R-θ image, wherein each said image element of the at least portion of said first image is relocated in said R-θ image to a position with respect to a first axis and a second axis according to the radius (R) and angular disposition (θ), respectively, of said image element with respect to a center and datum angle, respectively, in said first image;
(c) identifying said parameter value from said R-θ image by identifying an image corresponding to at least a part of said indicator therein and determining a position of said indicator with respect to said R-θ image;
(d) providing said coded data stream, wherein said data stream is representative of said parameter value;
(e) at least one of transmitting and recording said coded data stream.

25. A method according to claim 24, wherein at least one said coded data stream relates to a dial of a dial-type instrument, and step (ii) comprises creating an image of a dial at an angular disposition of said dial with respect to a datum, said angular position being correlated with said coded data stream.

26. A method according to claim 24, wherein said coded data stream comprises digital values representative of said angular disposition.

27. A method according to claim 23, wherein said parameter includes at least one of airspeed, altitude, pitch, roll, yaw, turn rate, vertical speed, horizontal situation (compass heading), engine rpm, oil status, fuel status, oil temperature, Mach number, chronological time.

28. A method according to claim 22, further comprising the step of displaying at least one of said attitude data, GPS data, DGPS data, altitude data, voice data, said digital data representative of said differences in step (C), in said coded data stream.

29. A method according to claim 22, comprising
providing a flight simulator program having capabilities of simulating a flight and of displaying instruments displays indicative of said flight from a vantage point of a user, wherein inputs for driving the instruments displays are normally provided by manipulation of suitable flight controls by said user;
adapting at least one of said flight simulator program and said coded data stream such that said inputs for said instruments displays are provided by said coded data stream.

30. A system for the acquisition of data from an instrument panel comprising at least one instrument angular display wherein a value of a parameter being monitored at the display is associated with at least an angular disposition of an indicator with respect to the display, comprising:—
(a) at least one first camera for providing a first image of said at least one display;
(b) processing system for processing said first image of said at least one display to provide a coded data stream representative of said image via a method comprising:—
(I) transforming at least a portion of said first image into a corresponding R-θ image, wherein each said predefined image element of the at least portion of said first image is relocated in said R-θ image to a position with respect to a first axis and a second axis according to the radius (R) and angular disposition (θ), respectively, of said predefined image element with respect to a center and datum angle, respectively, in said first image;
(II) identifying said parameter value from said R-θ image;
(III) providing said coded data stream, wherein said coded data stream is representative of said parameter value;
(c) at least one of transmitting apparatus and recording apparatus for transmitting and recording, respectively, said coded data stream.

31. A system according to claim 30, wherein said panel comprises a plurality of said displays, and said processing system is adapted for dividing the said image into a corresponding plurality of regions of interest (ROI), each said ROI comprising one said display, wherein said processing system processes said first image of each said readout to provide a corresponding plurality of coded data streams representative of said images.

32. A system according to claim 31, comprising at least one fiducial marker provided on said panel for aligning the said ROI with respect to an image of said marker.

33. A system according to claim 32, wherein said fiducial comprises a white outer annular portion circumscribing a dark central portion.

34. A system according to claim 31, wherein said at least one first camera and said panel are comprised in an aircraft cockpit.

35. A system according to claim 34, further comprising a crash proof device operatively connected to said processing system for recording said coded data streams therein.

36. A system according to claim 34, wherein said transmission apparatus comprises a suitable radio transmitter.

37. A system according to claim 30, further comprising at least one second camera for obtaining images of an external environment.

38. A system according to claim 37, further comprising at least one of: attitude data module, GPS system, DGPS system, altitude module, voice compression module.

39. A system for displaying data comprising:—
(i) at least one of data receiving apparatus and reading apparatus for receiving and reading, respectively, a coded data stream representative of an image of said at least one readout of an instrument panel;
(ii) processing apparatus for creating an image of said at least one readout based on said corresponding said coded data stream;
(iii) displaying apparatus for displaying said image in the context of an image representative of said panel.

40. A system according to claim 39, wherein said coded data stream is created by imaging said at least one instrument panel display to provide a first image thereof, and manipulating said first image to provide said coded data stream, wherein said coded data stream is representative of at least one value of a parameter being monitored at the display.

41. A system according to claim 39, wherein said coded data stream is created according to a method for acquiring data from an instrument panel having at least one instrument angular display wherein a value of a parameter being monitored at the display is associated with at least an angular disposition with respect to the display comprising:—
(a) providing a first image of said at least one angular display
(b) transforming at least a portion of said first image into a corresponding R-θ image, wherein each said image element of the at least portion of said first image is relocated in said R-θ image to a position with respect to a first axis and a second axis according to the radius (R) and angular disposition (θ), respectively, of said image element with respect to a center and datum angle, respectively, in said first image;
(c) identifying said parameter value from said R-θ image by identifying an image corresponding to at least a part of said indicator therein and determining a position of said indicator with respect to said R-θ image;
(d) providing said coded data stream, wherein said data stream is representative of said parameter value;
(e) at least one of transmitting and recording said coded data stream.

42. A system according to claim 39, wherein said processing apparatus is adapted for at least one of receiving and reading a data package comprising a plurality of said coded data streams, each representative of an image of one of a plurality of displays of said instrument panel.

43. A system according to claim 42, wherein said processing apparatus is adapted for dividing the data package into a corresponding plurality of coded data streams, and said display apparatus is adapted for displaying each image corresponding to a coded data stream in a window of said panel image corresponding to the position of the corresponding readout of said instrument panel.

44. A computer readable medium storing instructions for programming a processing means of a system to perform a method as defined in claim 1.

45. A computer readable medium storing instructions for programming a processing means of a system to perform a method as defined in claim 22.

46. A method for providing a simulation in a first location of an instrument status at a second location, comprising:
(a) providing an image of an instrument having said instrument status at said second location;
(b) analyzing said image to provide a measure of said instrument status;
(c) providing a coded data stream representative of said measure of said instrument status;
(d) transmitting said coded data stream to said first location
(e) receiving said coded data stream at said first location;
(f) simulating said instrument status by reconstructing and displaying a virtual image corresponding to said instrument based on said coded data stream, such that said virtual image comprises a representation of said instrument status.

47. A computer readable medium storing instructions for programming a processing means of a system to perform a method as defined in claim 45.

48. A system for providing a simulation in a first location of an instrument status at a second location, comprising:
(g) at least one first camera for providing an image of said instrument at said second location;
(h) first processing system for analyzing said image to provide a measure of said instrument status, and for providing a coded data stream representative of said measure of said instrument status;
(i) transmitting apparatus for transmitting said coded data stream to said first location;
(j) receiving apparatus at said first location for receiving said coded data stream;
(k) second processing system for simulating said instrument status by reconstructing a virtual image corresponding to said instrument based on said coded data stream, such that said virtual image comprises a representation of said instrument status, and first display apparatus for displaying said virtual image.

49. A system according to claim 48, further comprising a second display apparatus coupled to a flight simulation processor for displaying at said second location computer generated images of said instrument, and wherein said at least one camera is focused on said second display.
